(19) United States
(12) Patent Application Publication
(10) Pub. No.: US 2026/0254579 A1
(43) Pub. Date: Aug. 27, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/875,900

(22) PCT Filed: Jul. 8, 2022
(86) PCT No.: PCT/JP2022/027098

§ 371 Date: Dec. 17, 2024

(51) Int. Cl. H04L 5/00; H04W 72/21

(52) U.S. Cl. CPC H04L 5/0048; H04W 72/21

(57) ABSTRACT

A terminal according to one aspect of the present disclosure includes a receiving section that receives information related to a transmission scheme for an uplink shared channel (PUSCH) to be transmitted using at least one of a plurality of beams, panels, and transmission/reception points and downlink control information including information indicating an association between an uplink phase tracking reference signal (PTRS) and a demodulation reference signal (DMRS) for the PUSCH, and a control section that determines an association between ports of the PTRS and ports of the DMRS, based on the transmission scheme to be applied to the PUSCH, the downlink control information, and a number of the ports of the PTRS to be applied.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, Rel-18 NR or later versions), a UE can use one of a multi-panel (or a multi-beam) for uplink (UL) transmission. It is studied that simultaneous UL transmission using a plurality of panels (for example, simultaneous multi-panel UL transmission (SiMPUL)) is supported for one or more transmission/reception points (TRPs) for enhancement of throughput/reliability of the UL.

When multi-panel simultaneous UL transmission is supported, the UE simultaneously transmits a UL from two panels; however, sufficient studies have not been carried out on how to control UL transmission for one or more panels/TRPs.

In view of this, the present disclosure has one object to provide a terminal, a radio communication method, and a base station that can appropriately perform transmission control even when simultaneous transmission using a multi-panel is supported.

### Solution to Problem

A terminal according to one aspect of the present disclosure includes a receiving section that receives information related to a transmission scheme for an uplink shared channel (PUSCH) to be transmitted using at least one of a plurality of beams, panels, and transmission/reception points and downlink control information including information indicating an association between an uplink phase tracking reference signal (PTRS) and a demodulation reference signal (DMRS) for the PUSCH, and a control section that determines an association between ports of the PTRS and ports of the DMRS, based on the transmission scheme to be applied to the PUSCH, the downlink control information, and a number of the ports of the PTRS to be applied.

### Advantageous Effects of Invention

According to one aspect of the present disclosure, even when simultaneous transmission using a multi-panel is supported, transmission control can be appropriately performed.

### BRIEF DESCRIPTION OF DRAWINGS

FIG. 1 FIGS. 1A and 1B are diagrams to show examples of single-panel UL transmission.

FIG. 2 FIG. 2A to FIG. 2C are diagrams to show examples of schemes 1 to 3 for simultaneous UL transmission using a multi-panel.

FIG. 3 FIG. 3A to FIG. 3C are diagrams to show examples of PUSCH transmission schemes.

FIG. 4 FIG. 4A to FIG. 4C are diagrams to show other examples of PUSCH transmission schemes.

FIG. 5 FIG. 5A and FIG. 5B are diagrams to show examples of a PTRS-DMRS association field in Rel. 16.

FIG. 6 is a diagram to show an example of associations (or association candidates) between DMRS ports, PUSCH antenna ports, and PTRS ports.

FIG. 7 is a diagram to show an example of the PTRS-DMRS association field in Rel. 17.

FIG. 8 FIG. 8A and FIG. 8B are diagrams to show other examples of the PTRS-DMRS association field in Rel. 17.

FIG. 9 is a diagram to show an example of PUSCH transmission using an FDM-A scheme according to a first embodiment.

FIG. 10 is a diagram to show an example of the PTRS-DMRS association field and the association between the PTRS ports and the DMRS ports according to the first embodiment.

FIG. 11 is a diagram to show another example of the PTRS-DMRS association field and the association between the PTRS ports and the DMRS ports according to the first embodiment.

FIG. 12 is a diagram to show another example of the PTRS-DMRS association field and the association between the PTRS ports and the DMRS ports according to the first embodiment.

FIG. 13 is a diagram to show another example of the PTRS-DMRS association field and the association between the PTRS ports and the DMRS ports according to the first embodiment.

FIG. 14 is a diagram to show an example of PUSCH transmission using an FDM-B scheme according to a second embodiment.

FIG. 15 is a diagram to show an example of the PTRS-DMRS association field and the association between the PTRS ports and the DMRS ports according to the second embodiment.

FIG. 16 is a diagram to show another example of the PTRS-DMRS association field and the association between the PTRS ports and the DMRS ports according to the second embodiment.

FIG. 17 is a diagram to show an example of PUSCH transmission using an SDM scheme/SDM repetition according to a third embodiment.

FIG. 18 is a diagram to show an example of the PTRS-DMRS association field according to the third embodiment.

FIG. 19 is a diagram to show an example of the PTRS-DMRS association field and the association between the PTRS ports and the DMRS ports according to the third embodiment.

FIG. 20 is a diagram to show another example of the PTRS-DMRS association field according to the third embodiment.

FIG. 21 is a diagram to show another example of the PTRS-DMRS association field and the association between the PTRS ports and the DMRS ports according to the third embodiment.

FIG. 22 is a diagram to show another example of the PTRS-DMRS association field according to the third embodiment.

FIG. 23 is a diagram to show another example of the PTRS-DMRS association field and the association between the PTRS ports and the DMRS ports according to the third embodiment.

FIG. 24 is a diagram to show another example of the PTRS-DMRS association field according to the third embodiment.

FIG. 25 is a diagram to show another example of the PTRS-DMRS association field and the association between the PTRS ports and the DMRS ports according to the third embodiment.

FIG. 26 is a diagram to show another example of the PTRS-DMRS association field according to the third embodiment.

FIG. 27 is a diagram to show another example of the PTRS-DMRS association field and the association between the PTRS ports and the DMRS ports according to the third embodiment.

FIG. 28 is a diagram to show another example of the PTRS-DMRS association field according to the third embodiment.

FIG. 29 is a diagram to show another example of the PTRS-DMRS association field and the association between the PTRS ports and the DMRS ports according to the third embodiment.

FIG. 30 is a diagram to show another example of the PTRS-DMRS association field according to the third embodiment.

FIG. 31 FIG. 31A and FIG. 31B are diagrams to show examples of the number of PTRS ports to be transmitted to the TRPs.

FIG. 32 is a diagram to show an example of a schematic structure of a radio communication system according to one embodiment.

FIG. 33 is a diagram to show an example of a structure of a base station according to one embodiment.

FIG. 34 is a diagram to show an example of a structure of a user terminal according to one embodiment.

FIG. 35 is a diagram to show an example of a hardware structure of the base station and the user terminal according to one embodiment.

FIG. 36 is a diagram to show an example of a vehicle according to one embodiment.

### DESCRIPTION OF EMBODIMENTS

In future radio communication systems (for example, Rel-18 NR or later versions), it is assumed that simultaneous UL transmission using a plurality of beams/panels/TRPs (for example, simultaneous multi-panel UL transmission (SiMPUL)) is supported for one or more transmission/reception points (TRPs).

For example, in Rel. 18, simultaneous UL transmission using up to two TRPs/two panels is under study. In consideration of single-DCI-based and multi-DCI-based multi-TRP operations, it is also assumed that a total number of layers is up to four layers in all of the panels and a total number of codewords is up to two in all of the panels. As a matter of course, the number of TRPs, the number of panels, the number of layers, and the number of codewords are not limited to this.

### Single-Panel Transmission

As a single-panel UL transmission scheme or a single-panel UL transmission scheme candidate, at least one of the following transmission schemes A and B (single-panel UL transmission schemes A and B) may be applied. Note that, in the present disclosure, a panel/UE panel may be interpreted as a UE capability value set (for example, a UE capability value set) reported for each UE capability. In the present disclosure, different panel(s), different spatial relation(s), different joint TCI state(s), different TPC parameter(s), different antenna port(s), and the like may be interchangeably interpreted.

### Transmission Scheme A: Single-Panel Single-TRP UL Transmission

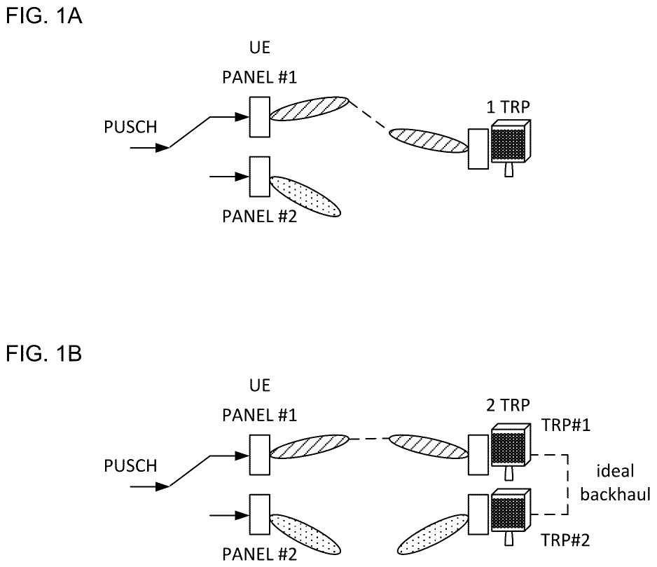

In Rel. 15 and Rel. 16, a transmission scheme is used in which the UE transmits a UL from only one beam and panel to one TRP at one time point (FIG. 1A).

### Transmission Scheme B: Single-Panel Multi-TRP UL Transmission

In Rel. 17, it is studied that UL transmission from only one beam and panel is performed and repetition transmission to a plurality of TRPs is performed at one time point (FIG. 1B). In the example of FIG. 1B, the UE transmits a PUSCH from panel #1 to TRP #1 (subsequently switches the beam and the panel), and transmits the PUSCH from panel #2 to TRP #2. Two TRPs are connected via an ideal backhaul.

### Multi-Panel Transmission

In Rel. 18 or later versions, it is studied that simultaneous UL transmission using a plurality of panels (for example, simultaneous multi-panel UL transmission (SiMPUL)) is supported for one or more TRPs for enhancement of UL throughput/reliability. Multi-panel UL transmission schemes are studied for certain UL channels (for example, a PUSCH/PUCCH) and the like.

As multi-panel UL transmission, for example, up to X (for example, X=2) and up to Y (for example, Y=2) panels may be supported. In multi-panel UL transmission, when UL precoding indication for the PUSCH is supported, codebooks of existing systems (for example, Rel. 16 or earlier versions) may be supported for multi-panel simultaneous transmission. In consideration of single-DCI and multi-DCI-based multi-TRP operations, the number of layers may be up to x (for example, x=4) in all of the panels, and the number of codewords (CWs) may be up to y (for example, y=2) in all of the panels.

As the multi-panel UL transmission scheme or the multi-panel UL transmission scheme candidate, at least one of the following schemes 1 to 3 (multi-panel UL transmission schemes 1 to 3) is under study. Only one of transmission schemes 1 to 3 may be supported. A plurality of schemes including at least one of transmission schemes 1 to 3 may be supported, and one of the plurality of transmission schemes may be configured for the UE.

### Transmission Scheme 1: Coherent Multi-Panel UL Transmission

A plurality of panels may be synchronized with each other. All of the layers are mapped to all of the panels. A plurality of analog beams are indicated. An SRS resource indicator (SRI) field may be enhanced. In the scheme, up to four layers may be used for the UL.

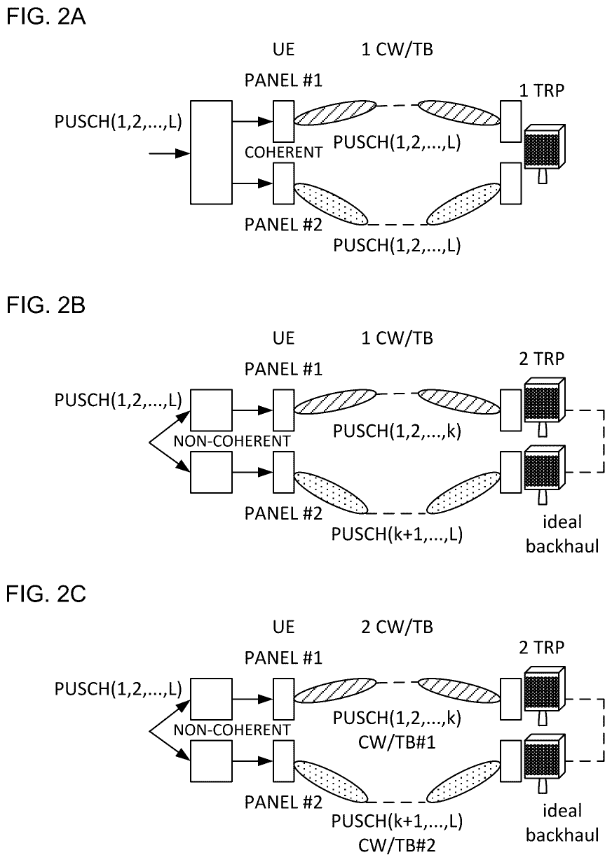

In the example of FIG. 2A, the UE maps one codeword (CW) or one transport block (TB) to L layers (PUSCH (1, 2, . . . , L)), and transmits the L layers from each of two panels. Panel #1 and panel #2 are coherent. In transmission scheme 1, gain due to diversity can be achieved. A total number of layers in two panels is 2L. When the maximum value of the total number of layers is 4, the maximum value of the number of layers in one panel is 2.

### Transmission Scheme 2: Non-Coherent Multi-Panel UL Transmission of One Codeword (CW) or Transport Block (TB)

A plurality of panels need not be synchronized. Different layers are mapped to different panels and one CW or TB for PUSCHs from a plurality of panels. A layer corresponding to one CW or TB may be mapped to a plurality of panels. In the transmission scheme, up to four layers or up to eight layers may be used for the UL. When up to eight layers are supported, the transmission scheme may support one CW or TB using up to eight layers.

In the example of FIG. 2B, the UE maps one CW or one TB to k layers (PUSCH (1, 2, . . . , k)) and L-k layers (PUSCH (k+1, k+2, . . . , L)), transmits the k layers from panel #1, and transmits the L-k layers from panel #2. In transmission scheme 2, gain due to multiplexing and diversity can be achieved. A total number of layers in two panels is L.

### Transmission Scheme 3: Non-Coherent Multi-Panel UL Transmission of Two CWs or TBs

A plurality of panels need not be synchronized. Different layers are mapped to different panels and two CWs or TBs for PUSCHs from a plurality of panels. A layer corresponding to one CW or TB may be mapped to one panel. A layer corresponding to a plurality 4 CWs or TBs may be mapped to a different panel. In the transmission scheme, up to four layers or up to eight layers may be used for the UL. When up to eight layers are supported, the transmission scheme may support up to four layers per CW or TB.

In the example of FIG. 2C, of two CWs or two TBs, the UE maps CW #1 or TB #1 to k layers (PUSCH (1, 2, . . . , k)), maps CW #2 or TB #2 to L-k layers (PUSCH (k+1, k+2, . . . , L)), transmits the k layers from panel #1, and transmits the L-k layers from panel #2. In transmission scheme 3, gain due to multiplexing and diversity can be achieved. A total number of layers in two panels is L.

In each of the transmission schemes described above, the base station may configure or indicate panel-specific transmission for UL transmission, using a UL TCI or a panel ID. The UL TCI (UL TCI state) may be based on signaling similar to a DL beam indication supported in Rel. 15. The panel ID may be implicitly or explicitly applied to transmission of at least one of target RS resources or a target RS resource set, a PUCCH, an SRS, and a PRACH. When the panel ID is explicitly notified, the panel ID may be configured in at least one (for example, DL RS resource configuration or spatial relation information) of a target RS, a target channel, and a reference RS.

In one or more transmission schemes/modes described above, multi-panel UL transmission (for example, simultaneous multi-panel transmission (Simultaneous Transmission across Multiple Panels (STxMP)) for scheduling of the PUSCH based on one DCI (single DCI)/scheduling of the PUSCH based on a plurality of DCIs (multi-DCI) is under study.

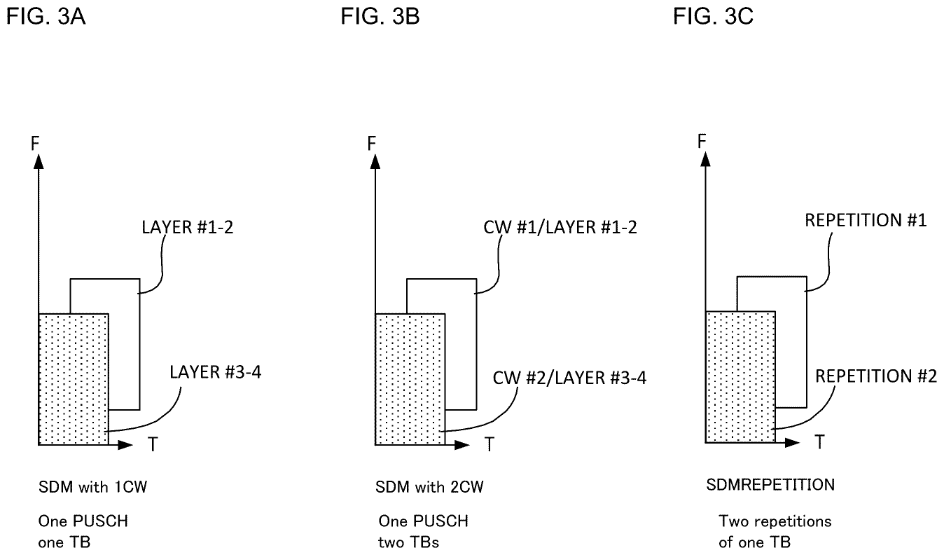

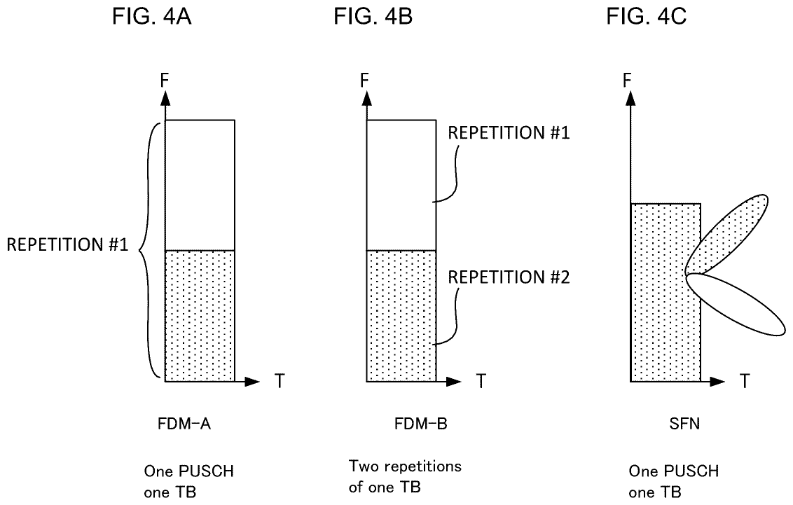

In simultaneous multi-panel transmission (STxMP) in a single-DCI based multi-TRP system, the following schemes may be applied to UL transmission (for example, the PUSCH).
Space division multiplexing (SDM) scheme: Different layers/DMRS ports of one PUSCH are separately precoded, and are simultaneously transmitted from different UE beams/panels (see FIG. 3A and FIG. 3B).
Space division multiplexing repetition (SDM repetition) scheme: Two PUSCH transmission occasions having different redundancy versions (RVs) of the same TB are simultaneously transmitted from two different UE beams/panels in the same time and frequency resources (see FIG. 3C).
Frequency division multiplexing (FDM)-A scheme: Different parts of frequency domain resources of a transmission occasion of one PUSCH (for example, one PUSCH transmission occasion) are transmitted from different UE beams/panels (see FIG. 4A).
FDM-B scheme: Two PUSCH transmission occasions having the same/different RV(s) of the same TB are transmitted from different UE beams/panels in non-overlapping frequency domain resources and the same time domain resources (see FIG. 4B).
SFN-based transmission scheme: All of the same layers/DMRS ports of one PUSCH are simultaneously transmitted from two different UE beams/panels (see FIG. 4C).

Note that, in the present disclosure, repetition transmission and transmission may be interchangeably interpreted. Transmission of a plurality of TBs may mean a plurality of transmissions of the Same TB or transmission of different TBs.

### Space Division Multiplexing (SDM)

The UE may assume that PUSCH repetition transmission to which space division multiplexing (SDM) is applied is scheduled in the same time resources and the same frequency resources. In other words, when a plurality of coherent panels are used, the UE may transmit PUSCH repetition transmission to which SDM is applied in the same time resources and the same frequency resources.

FIG. 3A is a diagram to show an example of repetition transmission to which SDM is applied with one CW. In FIG. 3A, the time and frequency resources of layer #1-2 and layer #3-4 corresponding to the PUSCH/PUCCH are the same.

FIG. 3B is a diagram to show an example of repetition transmission to which SDM is applied with two CWs. In FIG. 3B, the time and frequency resources of CW #1 and CW #2 corresponding to the PUSCH/PUCCH are the same.

FIG. 3C is a diagram to show an example of repetition transmission to which SDM is applied. In FIG. 3C, the time and frequency resources of repetition #1 and repetition #2 of the PUSCH/PUCCH are the same.

Note that, in PUSCH transmission to which SDM is applied (for example, PUSCH repetition transmission), at least a part of the time and frequency resources may overlap.

### Frequency Division Multiplexing (FDM)

The UE may assume that PUSCH/PUCCH repetition transmission to which frequency division multiplexing (FDM) is applied is scheduled in the same time resources and different frequency resources. In other words, when a plurality of coherent panels are used, the UE may transmit PUSCH/PUCCH repetition transmission to which FDM is applied in the same time resources and different frequency resources.

FIG. 4A is a diagram to show a first example of repetition transmission to which FDM (FDM-A) is applied. FIG. 4A shows an example in which one PUSCH/PUCCH repetition transmission is performed per TB/UCI.

FIG. 4B is a diagram to show a second example of repetition transmission to which FDM (FDM-B) is applied. FIG. 4B shows an example in which two PUSCH/PUCCH repetition transmissions are performed per TB/UCI.

FIG. 4C is a diagram to show an example of repetition transmission to which a single frequency network (SFN) is applied. FIG. 4C shows an example in which one PUSCH/PUCCH is transmitted using different beams/panels per TB/UCI.

### PTRS

In Rel-15 NR, a phase tracking reference signal (PTRS) is supported. The base station may transmit the PTRS in the downlink. The base station may continuously or discontinuously map the PTRS in the time direction and transmit the PTRS in a certain number of (for example, one) subcarrier(s).

For example, the UE may receive the PTRS in at least a part of a time period (a slot, a symbol, or the like) in which a downlink shared channel (Physical Downlink Shared Channel (PDSCH)) is scheduled (that is, a time period in which the PDSCH is received). The PTRS transmitted by the base station may be referred to as a DL PTRS.

The UE may transmit the PTRS in the uplink. The UE may continuously or discontinuously map the PTRS in the time direction and transmit the PTRS in a certain number of (for example, one) subcarrier(s).

For example, the UE may transmit the PTRS in at least a part of a time period (a slot, a symbol, or the like) in which an uplink shared channel (Physical Uplink Shared Channel (PUSCH)) is scheduled (that is, a time period in which the PUSCH is transmitted). The PTRS transmitted by the UE may be referred to as a UL PTRS.

The base station or the UE may determine phase noise based on the received PTRS, and correct a phase error of the received signal (for example, the PUSCH, the PDSCH).

The UE may be configured with PTRS configuration information (PTRS-DownlinkConfig for the DL, PTRS-UplinkConfig for the UL), using higher layer signaling. For example, the PTRS configuration information may be included in configuration information (DMRS-DownlinkConfig, DMRS-UplinkConfig) of a demodulation reference signal (DMRS) of the PDSCH or the PUSCH.

### PTRS and DMRS

In NR (for example, Rel. 15), it is assumed that a DMRS port associated with a PTRS port is quasi co-located (QCL) with respect to QCL types A and D. In other words, when a certain PTRS port is associated with a certain DMRS port, it may be assumed that the PTRS port and the DMRS port are in a relationship of QCL types A and D with each other.

In Rel-16 NR, it is supported that an association between the PTRS port and the DMRS port (for example, a PTRS-DMRS association) is indicated by a certain field in DCI. The certain field may be referred to as a PTRS-DMRS association field or a PTRS-DMRS association field (for example, a PTRS-DMRS association field).

Incidentally, in Rel-16 NR, supporting up to two PTRS ports (a first PTRS port and a second PTRS port) is agreed for single-PDCCH-based multi-panel/TRP transmission. The number of PTRS ports (for example, one or two PTRS ports) to be applied/configured may be notified to the UE by a higher layer parameter.

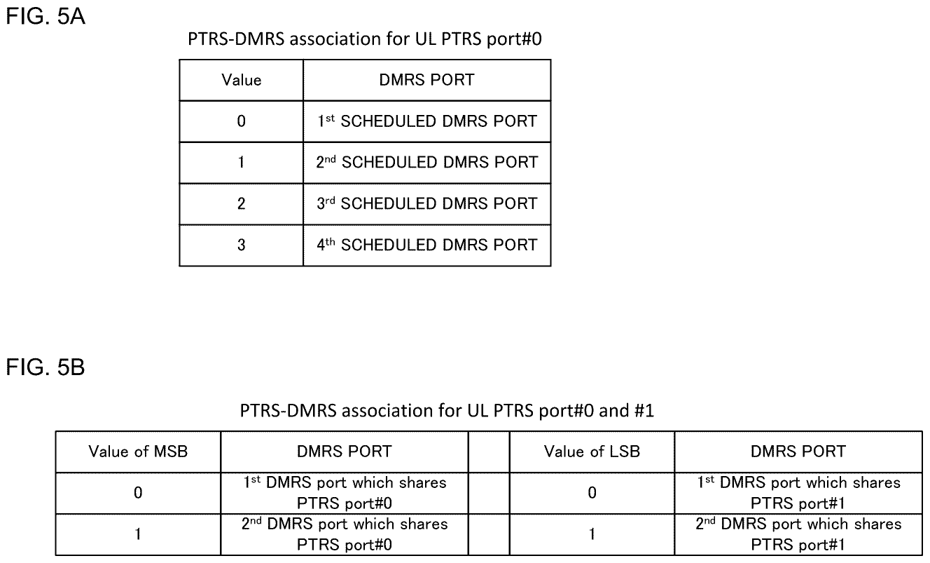

When one PTRS port (for example, PTRS port #0) is configured, the association between the PTRS and the DMRS may be determined based on codepoints indicated by the PTRS-DMRS association field in DCI and a correspondence (for example, a table) between the codepoints and the DMRS ports. The correspondence (for example, the table) between the codepoints and the DMRS ports may be defined in advance (see FIG. 5A).

FIG. 5A shows a case in which certain DMRS ports respectively correspond to (here, first to fourth scheduled DMRS ports respectively correspond to) the codepoints (here, 0 to 3) of the PTRS-DMRS association field.

When two PTRS ports (for example, PTRS port #0 and PTRS port #1) are configured, the association between the PTRS and the DMRS may be determined based on codepoints indicated by the PTRS-DMRS association field in DCI and a correspondence (for example, a table) between the codepoints and the DMRS ports. The correspondence (for example, the table) between the codepoints and the DMRS ports may be defined in advance (see FIG. 5B).

For example, some codepoints (for example, most significant bits (MSBs) out of a plurality of codepoints may be used for indication of the DMRS port for PTRS port #0, and the rest of the codepoints (for example, least significant bits (LSBs) may be used for indication of the DMRS port for PTRS port #1.

FIG. 5B shows a case in which a first DMRS out of the DMRSs sharing PTRS #0 is indicated when the MSB (here, 1 bit) is 0 and a second DMRS out of the DMRSs sharing PTRS #0 is indicated when the MSB is 1. A case is shown in which the first DMRS out of the DMRSs sharing PTRS #0 is indicated when the LSB (here, 1 bit) is 0 and the second DMRS out of the DMRSs sharing PTRS #0 is indicated when the MSB is 1.

Information related to the DMRSS (for example, the first DMRS/second DMRS) sharing the PTRSs (here, PTRSs #0 and #1) may be defined in a specification in advance, or may be explicitly or implicitly notified from the base station to the UE by DCI/RRC.

For example, PUSCH antenna ports corresponding to the PTRS ports may be defined/configured in advance, and certain information related to a correspondence between the PUSCH antenna ports and the DMRS ports may be notified to the UE by DCI/RRC. The UE may determine an association between the DMRS ports and the PTRS ports, based on information related to the correspondence between the DMRS ports and the PUSCH antenna ports notified from the base station and the correspondence between the PUSCH antenna ports and the PTRS ports defined in advance.

The certain information related to the correspondence between the PUSCH antenna ports and the DMRS ports may be indicated to the UE by a certain field included in DCI (for example, DCI used for scheduling of the PUSCH). The certain field may be at least one of a “precoding information and number of layers” field and an “antenna ports” field.

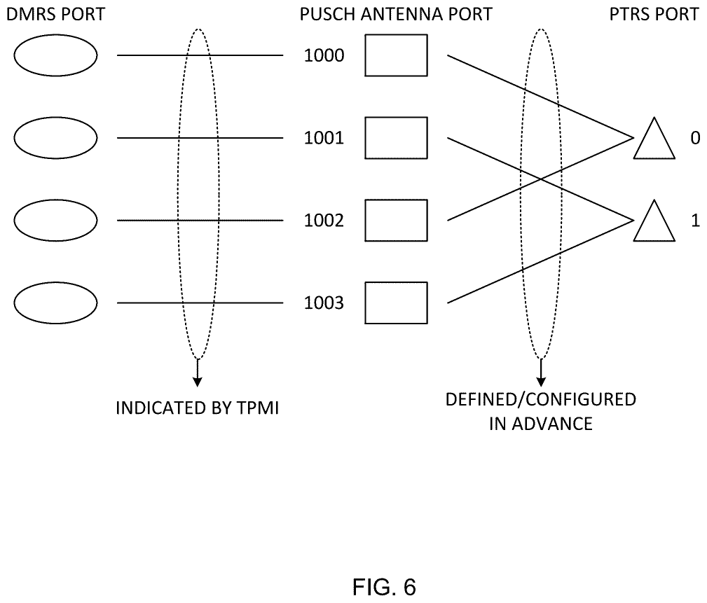

For example, it may be defined that PUSCH antenna ports 1000 and 1002 in an indicated transmitted precoding matrix indicator (TPMI) share PTRS port #0 and PUSCH antenna ports 1001 and 1003 in the indicated TPMI share PTRS port #1. The TPMI may be indicated by the “precoding information and number of layers” field in DCI (see FIG. 6).

PTRS port #0 may be associated with a UL layer ‘x’ of a plurality of layers transmitted in the PUSCH antenna port 1000 and the PUSCH antenna port 1002 in the indicated TPMI. PTRS port #1 may be associated with a UL layer “y” of a plurality of layers transmitted in the PUSCH antenna port 1001 and the PUSCH antenna port 1003 in the indicated TPMI. x/y may be given by the PTRS-DMRS association field (for example, FIG. 5B) included in DCI.

It may be defined in a specification that PUSCH antenna ports 1000 and 1002 share PTRS port #0 and PUSCH antenna ports 1001 and 1003 share PTRS port #1. Certain information (hereinafter also simply referred to as the “TPMI”) from the base station may indicate which layer/DMRS port is transmitted in which PUSCH antenna port. This means that the TPMI indicates which layer/DMRS port shares which PTRS port. The PTRS-DMRS association field may indicate that one layer/DMRS port out of a plurality of layers/DMRS ports shares the PTRS port.

In Rel. 17, multi-TRP PUSCH repetition using time division multiplexing (TDM) (for example, TDM M-TRP PUSCH repetition) is supported. The PTRS-DMRS association may be indicated per TRP.

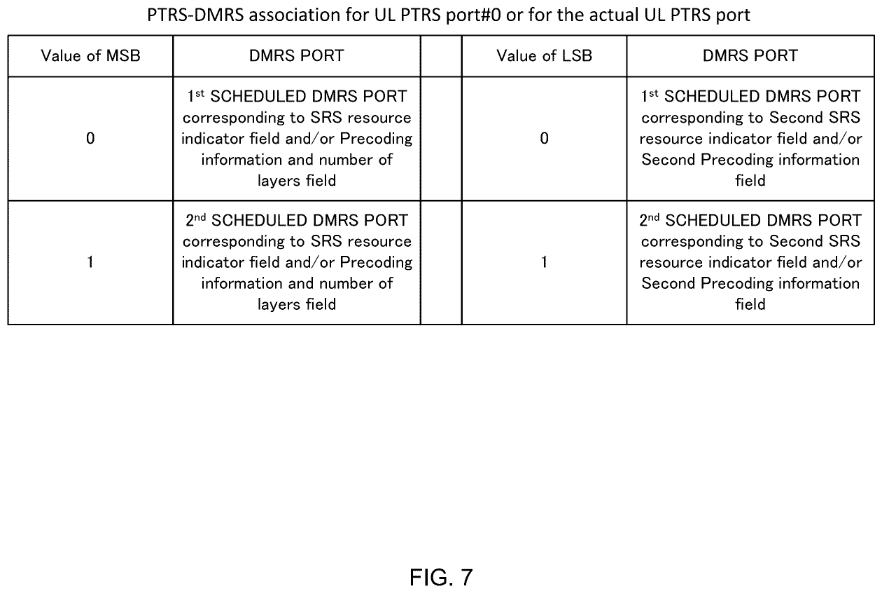

When a maximum rank is 2 (for example, maxrank=2) and one PTRS port is used, the PTRS-DMRS association for two TRPs may be indicated by the PTRS-DMRS association field (for example, one field). For example, the MSB of the PTRS-DMRS association field may indicate a first TRP, and the LSB of the PTRS-DMRS association field may indicate a second TRP (see FIG. 7).

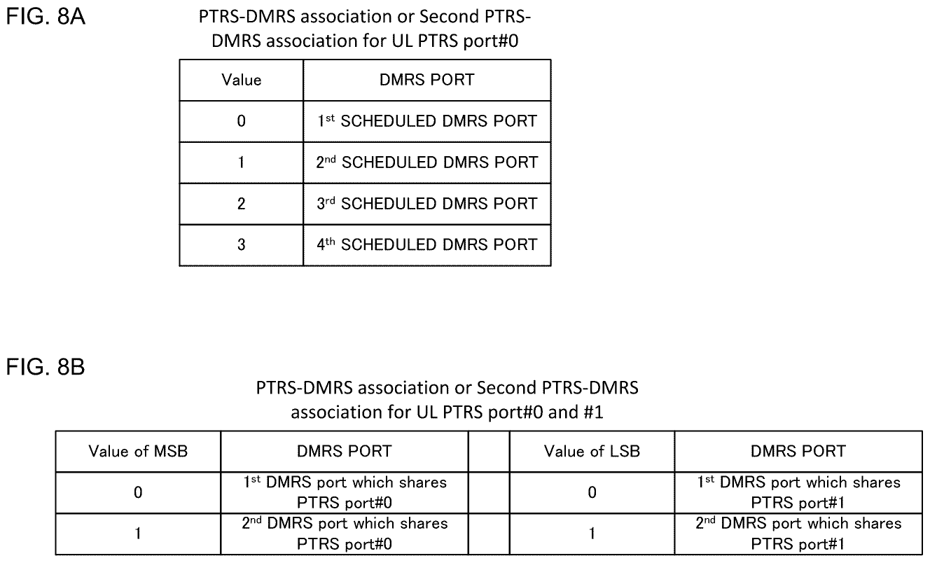

When the maximum rank is greater than 2 (for example, maxrank>2) and one or two PTRS ports are used, the PTRS-DMRS association for two TRPs may be indicated by the PTRS-DMRS association field and a second PTRS-DMRS association field (see FIG. 8A and FIG. 8B). FIG. 8A shows an example of the PTRS-DMRS association field when one PTRS is configured/applied, and FIG. 8B shows an example of the PTRS-DMRS association field when two PTRSs are configured/applied.

Incidentally, in future radio communication systems (for example, Rel-18 NR), when an STAMP PUSCH in a single-DCI-based multi-TRP is supported, how to control/apply the PTRS-DMRS association in each scheme (for example, FDM/SDM) presents a problem. For example, whether the PTRS-DMRS association is made common in two panels/two TRPs or is separately controlled for each panel/TRP presents a problem. How the PTRS-DMRS association is indicated presents a problem.

In view of this, the inventors of the present invention studied a method for appropriately controlling UL transmission even when simultaneous transmission using a multi-panel is supported, and came up with the idea of the present embodiment.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C”.

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information (one or a plurality of spatial relation information)”, and the like. The TCI state and the TCI may be interchangeably interpreted.

### Radio Communication Method

When the UE performs UL transmission (for example, the PUSCH) using one or more beams/panels/TRPs (for example, first/second beam/panel/TRP), the UE may determine the association between the DMRS ports associated with the UL transmission and the PTRS ports, based on a certain condition. The certain condition may be at least one of (or a combination of two or more of) the transmission scheme to be applied/configured for the UL transmission (for example, the PUSCH), the PTRS-DMRS association (for example, PTRS-DMRS association) field indicated by DCI, the number of PTRS ports to be applied/configured, the transmitted precoding matrix indicator (TPMI) field, and certain information. The certain information may be information indicated/configured by DCI/higher layer parameter (for example, information related to the UL transmission/information related to a parameter to be applied to the UL transmission).

The PTRS-DMRS association field/TPMI association field may be included in DCI for scheduling the PUSCH. At least one of the number of bits and the number of fields of the PTRS-DMRS association field/TPMI association field included in DCI may be defined in a specification, may be configured by a higher layer parameter/DCI, or may be variable based on a certain parameter. The certain parameter may be at least one of the number of PTRS ports and the transmission scheme to be applied/configured, for example.

The first/second beam/panel/TRP may be a first/second SRI/TCI state, a first/second SRI field/TCI state field, a first/second SRS resource set (for example, an SRS resource set having a low ID/high ID), a low/high panel ID (for example, a lower/higher panel ID), or a low/high TRP ID (for example, a lower/higher TRP ID). The panel may refer to a UE capability value set (for example, a UE capability value set) or another definition (for example, a UE antenna group).

The first/second beam/panel/TRP may be indicated by at least one of DCI, a MAC CE, and RRC. For example, it may be indicated by two SRI fields in PUSCH repetition of Rel. 17. Alternatively, it may be indicated by one or two TCI state fields.

In the following description, the MSB of the field may be interpreted as a first bit, and the LSB thereof may be interpreted as a second bit.

In the following description, description will be given by taking an example of a case using two beams/panels/TRPs; however, the number of applicable beams/panels/TRPs is not limited to this. The present embodiment may also be similarly applied to a case in which a plurality of, specifically three of more, beams/panels/TRPs, are applied.

### First Embodiment

A first embodiment relates to a case in which FDM (for example, FDM-A) is configured for UL transmission. “Configure” may be interpreted as “indicate”, “apply”, “activate”, or “enable”.

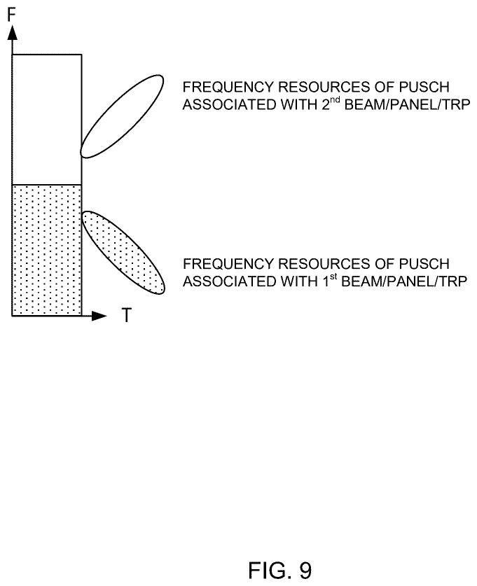

When the UE performs UL transmission (here, a PUSCH) using a plurality of (for example, two) beams/panels/TRPs, different parts of frequency domain resources of one PUSCH transmission occasion may be transmitted from different UE panels (see FIG. 9). The UE may transmit one PUSCH (or one TB), using different parts of frequency domain resources of one PUSCH transmission occasion.

Frequency resources (for example, resource blocks) of the PUSCH associated with a first beam/panel/TRP and frequency resources of the PUSCH associated with a second beam/panel/TRP may correspond to different frequency domain resources of one PUSCH transmission occasion.

Two beams/panels/TRPs may have the same DMRS port/same TPMI. In the following description, a case is assumed in which two beams/panels/TRPs have the same DMRS port and the same TPMI, but this is not restrictive. Similar application may also be carried out when three or more beams/panels/TRPs are used.

### Option 1-1

When UL transmission using two beams/panels/TRPs is supported, one PTRS-DMRS association (for example, a PTRS-DMRS association) may be indicated from the base station to the UE. For example, the base station may indicate one PTRS-DMRS association to the UE, using the PTRS-DMRS association field included in DCI. As an example, the PTRS-DMRS association field supported in Rel. 16 may be reused.

When UL transmission using two beams/panels/TRPs is supported, the PTRS port(s) (for example, one or more PTRS ports) may be associated with the same DMRS port(s) (for example, one or more DMRS ports).

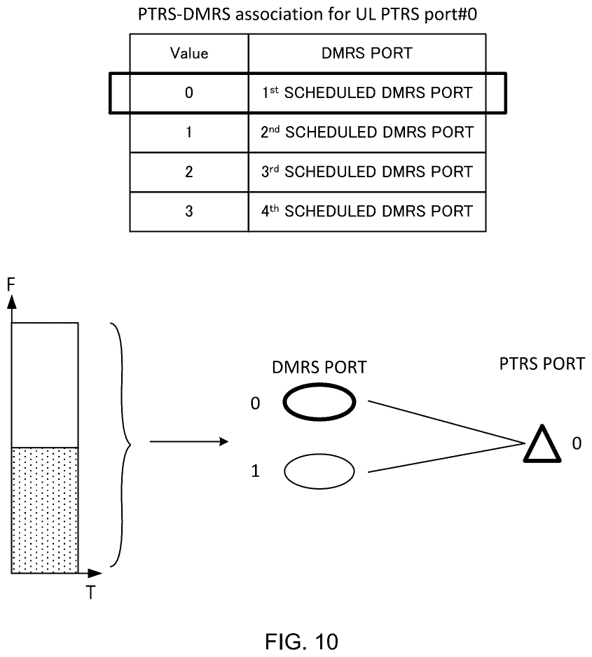

FIG. 10 is a diagram to show an example of the PTRS-DMRS association when one PTRS (for example, PTRS port 0) is configured/applied. A case is shown in which the PTRS-DMRS association field (here, 0) included in DCI indicates a certain DMRS port (here, a 1^{st} scheduled DMRS port). In this case, it may mean that PTRS port 0 is associated with DMRS port 0.

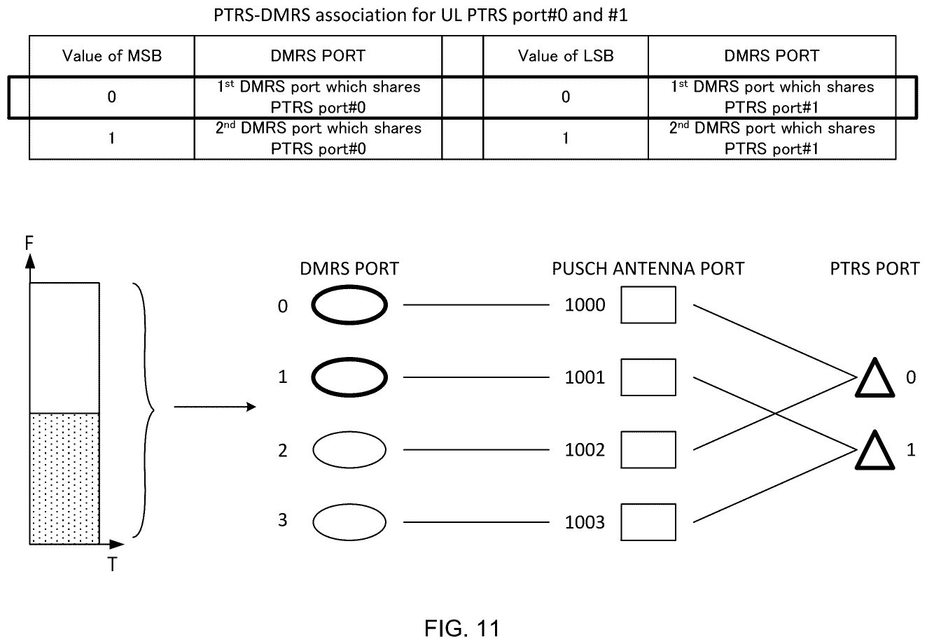

FIG. 11 is a diagram to show an example of the PTRS-DMRS association when two PTRSs (for example, PTRS port 0 and PTRS port 1) are configured/applied. A case is shown in which the PTRS-DMRS association field (here, the MSB is 0 and the LSB is 0) included in DCI indicates the DMRS port corresponding to PTRS port 0 and the DMRS port corresponding to PTRS port 1.

FIG. 11 shows a case in which the DMRS port associated with PTRS port 0 corresponds to a first DMRS port sharing PTRS port 0 and the DMRS port associated with PTRS port 1 corresponds to a first PTRS port sharing PTRS port 1. In this case, it may mean that PTRS port 0 is associated with DMRS port 0 and PTRS port 1 is associated with DMRS port 1.

Note that the correspondence between the DMRS ports and the PUSCH antenna ports may be determined based on the TPMI field included in DCI or the certain condition. The correspondence (for example, the TPMI field) between the DMRS ports and the PUSCH antenna ports may be applied in common to the first beam/panel/TRP and the second beam/panel/TRP.

### Option 1-2

When UL transmission using two beams/panels/TRPs is supported, two PTRS-DMRS associations may be respectively indicated. For example, the base station may indicate two PTRS-DMRS associations to the UE, using the PTRS-DMRS association field included in DCI. As an example, the PTRS-DMRS association field supported in Rel. 17 may be reused.

When the maximum rank is 2 (maxRank=2) and one PTRS port is used, the PTRS-DMRS association of two beams/panels/TRPs may be indicated by the PTRS-DMRS association field (one field). The MSB of the PTRS-DMRS association field may correspond to the first beam/first panel/first TRP, and the LSB of the PTRS-DMRS association field may correspond to the second beam/second panel/second TRP.

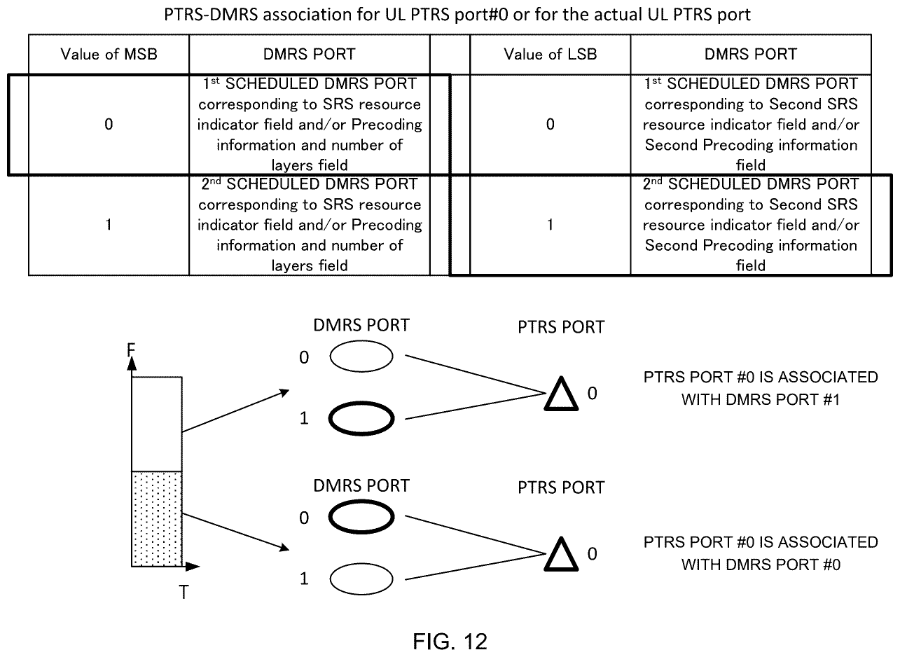

FIG. 12 is a diagram to show an example of the PTRS-DMRS association when one PTRS (for example, PTRS port 0 or an actual PTRS port) is configured/applied. A case is shown in which the PTRS-DMRS association field (the MSB is 0 and the LSB is 1) included in DCI indicates the PTRS-DMRS association for the first beam/first panel/first TRP and the PTRS-DMRS association for the second beam/second panel/second TRP.

In the case shown in FIG. 12, it may mean that PTRS 0 is associated with DMRS port 0 in the first beam/first panel/first TRP (or first frequency domain resources in the PUSCH transmission occasion), and it may mean that PTRS 0 is associated with DMRS port 1 in the second beam/second panel/second TRP (or second frequency domain resources in the PUSCH transmission occasion).

When the maximum rank is greater than 2 (maxRank>2) and one or two PTRS ports are used, the PTRS-DMRS association of two beams/panels/TRPs may be indicated by the PTRS-DMRS association field and the second PTRS-DMRS association field (for example, two fields). The PTRS-DMRS association field may correspond to the first beam/first panel/first TRP, and the second PTRS-DMRS association field may correspond to the second beam/second panel/second TRP.

Regarding the first/second beam/TRP, the first/second SRI field may be referred to. When two SRI fields are reused and the two SRI fields correspond to two beams/panels/TRPs of FDM-A, the PTRS-DMRS association of Rel. 17 may be applied.

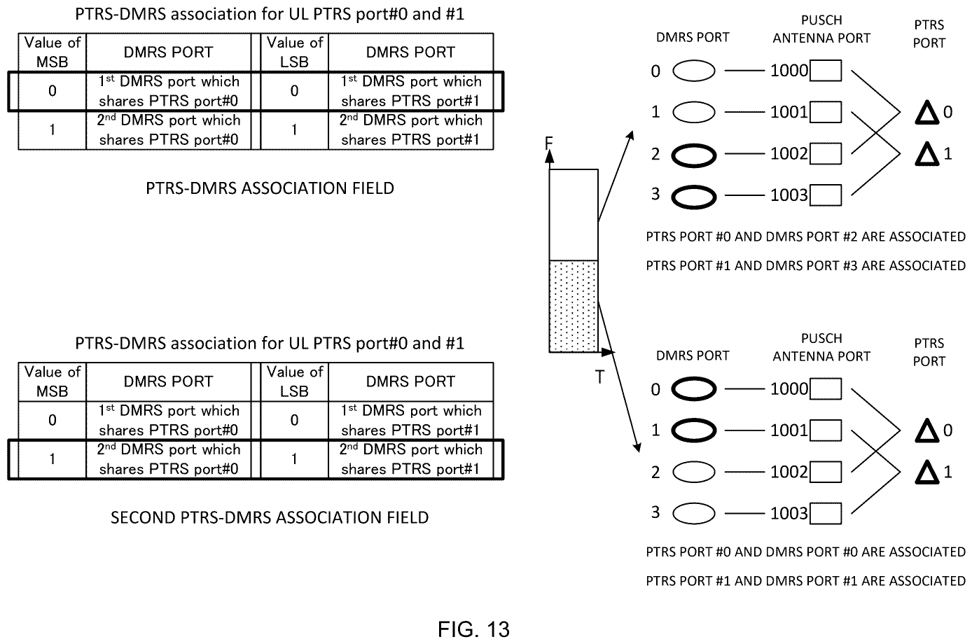

FIG. 13 is a diagram to show an example of the PTRS-DMRS association when two PTRSs (for example, PTRS port 0 and PTRS port 1) are configured/applied. A case is shown in which the PTRS-DMRS association field and the second PTRS-DMRS association field included in DCI indicate the PTRS-DMRS association for the first beam/first panel/first TRP and the PTRS-DMRS association for the second beam/second panel/second TRP.

In FIG. 13, the PTRS-DMRS association field (here, the MSB is 0 and the LSB is 0) included in DCI indicates the PTRS-DMRS association for the first beam/first panel/first TRP. In this case, it means that PTRS 0 is associated with DMRS port 0 (first DMRS port sharing PTRS port 0) and PTRS 1 is associated with DMRS port 1 (first DMRS port sharing PTRS port 1) in the first beam/first panel/first TRP (or first frequency domain resources in the PUSCH transmission occasion).

The second PTRS-DMRS association field (here, the MSB is 1 and the LSB is 1) included in DCI indicates the PTRS-DMRS association for the second beam/second panel/second TRP. In this case, it means that PTRS 0 is associated with DMRS port 2 (second DMRS port sharing PTRS port 0) and PTRS 1 is associated with DMRS port 3 (second DMRS port sharing PTRS port 1) in the second beam/second panel/second TRP (or second frequency domain resources in the PUSCH transmission occasion).

### Variations

When UL transmission using two beams/panels/TRPs is supported and two PTRS-DMRS associations are respectively indicated, two PTRS-DMRS association fields may be applied regardless of the number/value of maximum rank(s).

For example, regardless of whether the maximum rank is 2 or greater than 2, the PTRS-DMRS association of two beams/panels/TRPs may be indicated by the PTRS-DMRS association field and the second PTRS-DMRS association field (two fields). The PTRS-DMRS association field may correspond to the first beam/first panel/first TRP, and the second PTRS-DMRS association field may correspond to the second beam/second panel/second TRP.

The UE may determine the number of PTRS-DMRS association fields, based on the number of PTRS ports to be applied/configured. For example, when a plurality of (for example, two) PTRS ports are applied/configured, the UE may assume that two PTRS-DMRS association fields are included in DCI, regardless of the number of maximum ranks.

### Second Embodiment

A second embodiment relates to a case in which the FDM (for example, FDM-B) scheme is configured for UL transmission. “Configure” may be interpreted as “indicate”, “apply”, “activate”, or “enable”.

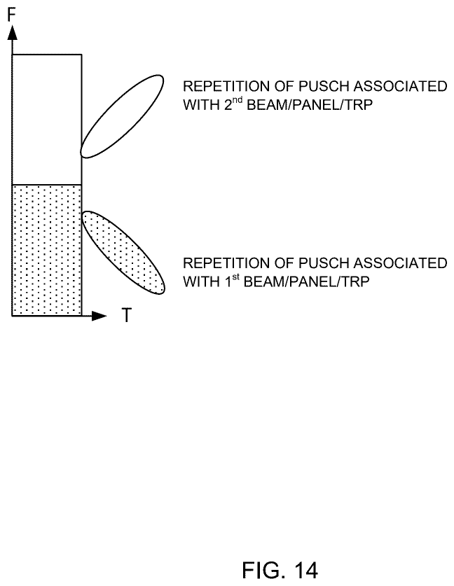

When the UE performs UL transmission (here, a PUSCH) using a plurality of (for example, two) beams/panels/TRPs, two PUSCH transmission occasions having the same/different redundancy version(s) (same/different RV(s)) of the same transport block (for example, the TB) may be transmitted from different UE panels in non-overlapping frequency domain resources and the same time domain resources (see FIG. 14). The UE may transmit PUSCH repetition (or PUSCH repetition of one TB), using two PUSCH transmission occasions corresponding to different frequency domains at the same time.

Repetition of the PUSCH associated with the first beam/panel/TRP may correspond to a first PUSCH transmission occasion, and repetition of the PUSCH associated with the second beam/panel/TRP may correspond to a second PUSCH transmission occasion.

Two beams/panels/TRPs may have the same DMRS port/different TPMIs. In the following description, a case is assumed in which two beams/panels/TRPs have the same DMRS port and different TPMIs, but this is not restrictive. Similar application may also be carried out when three or more beams/panels/TRPs are used.

The following option 2-1 to option 2-2 may be applied as with the options of the first embodiment (FDM-A). Note that, in FDM-B, different TPMIs are applied to two beams/panels/TRPs. Thus, unlike FDM-A, the PTRS-DMRS association of each beam/panel/TRP may be determined for each TPMI of the beam/panel/TRP, in consideration of a PTRS-DMRS association indication.

### Option 2-1

When UL transmission using two beams/panels/TRPs is supported, one PTRS-DMRS association may be indicated from the base station to the UE. For the first/second beam/panel/TRP, the association between the PTRS ports and the DMRS ports may be determined according to the PTRS-DMRS association and a first/second TPMI, respectively. The first/second TPMI may correspond to the first/second beam/panel/TRP, respectively.

For example, the base station may indicate one PTRS-DMRS association to the UE, using the PTRS-DMRS association field included in DCI. As an example, the PTRS-DMRS association field supported in Rel. 16 may be reused.

In this case, the base station may separately indicate the associations between the PTRS ports and the DMRS ports for PUSCHs (or PUSCHs using the beams/panels/TRPs), using the TPMI field(s) included in DCI, respectively. One TPMI field may indicate two TPMIs (for example, the first/second TPMI), or two TPMI fields may indicate two TPMIs (for example, the first/second TPMI).

For the PTRS-DMRS association when one PTRS (for example, PTRS port 0) is configured/applied, the method described in option 1-1 may be applied.

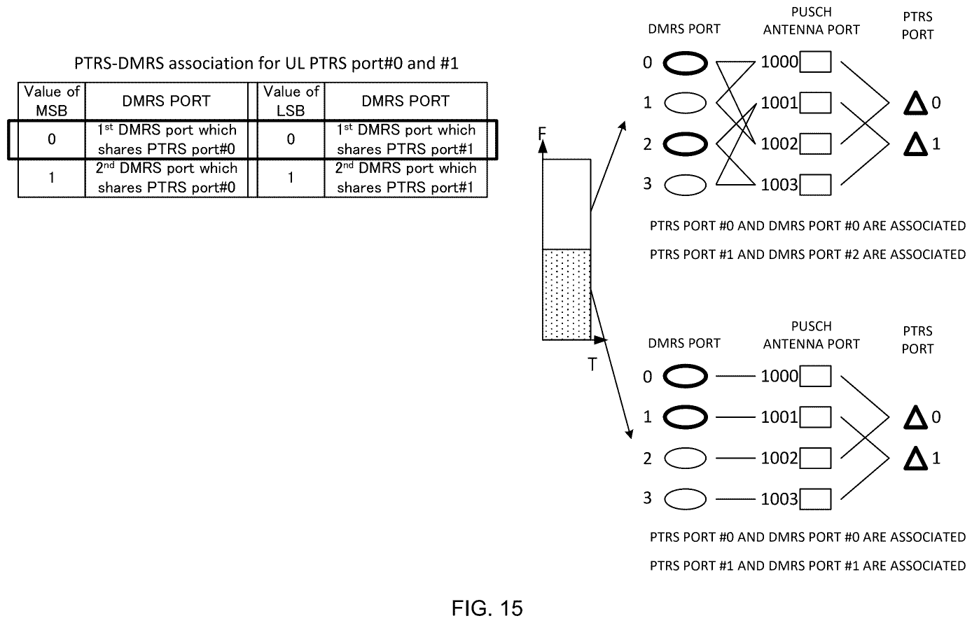

FIG. 15 is a diagram to show an example of the PTRS-DMRS association when two PTRSs (for example, PTRS port 0 and PTRS port 1) are configured/applied. A case is shown in which the PTRS-DMRS association field (here, the MSB is 0 and the LSB is 0) included in DCI indicates the DMRS port corresponding to PTRS port 0 and the DMRS port corresponding to PTRS port 1.

FIG. 15 shows a case in which the DMRS port associated with PTRS port 0 corresponds to the first DMRS port sharing PTRS port 0 and the DMRS port associated with PTRS port 1 corresponds to the first PTRS port sharing PTRS port 1.

The first TPMI and the second TPMI may separately indicate the correspondence between the DMRS ports and the PUSCH antenna ports to the UE. Here, the first TPMI indicates that DMRS port 0 and PUSCH antenna ports 1000 and 1002 correspond to each other, DMRS port 1 and PUSCH antenna ports 1000 and 1002 correspond to each other, DMRS port 2 and PUSCH antenna ports 1001 and 1003 correspond to each other, and DMRS port 3 and PUSCH antenna ports 1001 and 1003 correspond to each other. The second TPMI indicates that DMRS port 0 and PUSCH antenna port 1000 correspond to each other, DMRS port 1 and PUSCH antenna port 1001 correspond to each other, DMRS port 2 and PUSCH antenna port 1002 correspond to each other, and DMRS port 3 and PUSCH antenna port 1003 correspond to each other.

In this case, it may mean that PTRS port 0 is associated with DMRS port 0 and PTRS port 1 is associated with DMRS port 1 for the first beam/panel/TRP (or the first PUSCH transmission occasion).

It may mean that PTRS port 0 is associated with DMRS port 0 and PTRS port 1 is associated with DMRS port 2 for the second beam/panel/TRP (or the second PUSCH transmission occasion).

### Option 2-2

For two beams/panels/TRPs, two PTRS-DMRS associations may be respectively indicated. For example, the base station may indicate two PTRS-DMRS associations to the UE, using the PTRS-DMRS association field included in DCI. As an example, the PTRS-DMRS association field supported in Rel. 17 may be reused.

When the maximum rank is 2 (maxRank=2) and one PTRS port is used, the PTRS-DMRS association of two beams/panels/TRPs may be indicated by the PTRS-DMRS association field (one field). The MSB of the PTRS-DMRS association field may correspond to the first beam/first panel/first TRP, and the LSB of the PTRS-DMRS association field may correspond to the second beam/second panel/second TRP.

For the PTRS-DMRS association when one PTRS (for example, PTRS port 0) is configured/applied, the method described in option 1-2 may be applied.

When the maximum rank is greater than 2 (maxRank>2) and one or two PTRS ports are used, the PTRS-DMRS association of two beams/panels/TRPs may be indicated by the PTRS-DMRS association field and the second PTRS-DMRS association field (for example, two fields). The PTRS-DMRS association field may correspond to the first beam/first panel/first TRP, and the second PTRS-DMRS association field may correspond to the second beam/second panel/second TRP.

Regarding the first/second beam/TRP, the first/second SRI field/TPMI field may be referred to. When two SRI fields/TPMI fields are reused and the two SRI fields/TPMI fields correspond to two beams/panels/TRPs of FDM-B, the PTRS-DMRS association of Rel. 17 may be applied.

### Variations

When two PTRS-DMRS associations are respectively indicated for two beams/panels/TRPs, two PTRS-DMRS association fields may be applied regardless of the number/value of maximum rank(s). Regardless of whether the maximum rank is 2 or greater than 2, the PTRS-DMRS association of two beams/panels/TRPs may be indicated by the PTRS-DMRS association field and the second PTRS-DMRS association field (two fields). The PTRS-DMRS association field may correspond to the first beam/first panel/first TRP, and the second PTRS-DMRS association field may correspond to the second beam/second panel/second TRP.

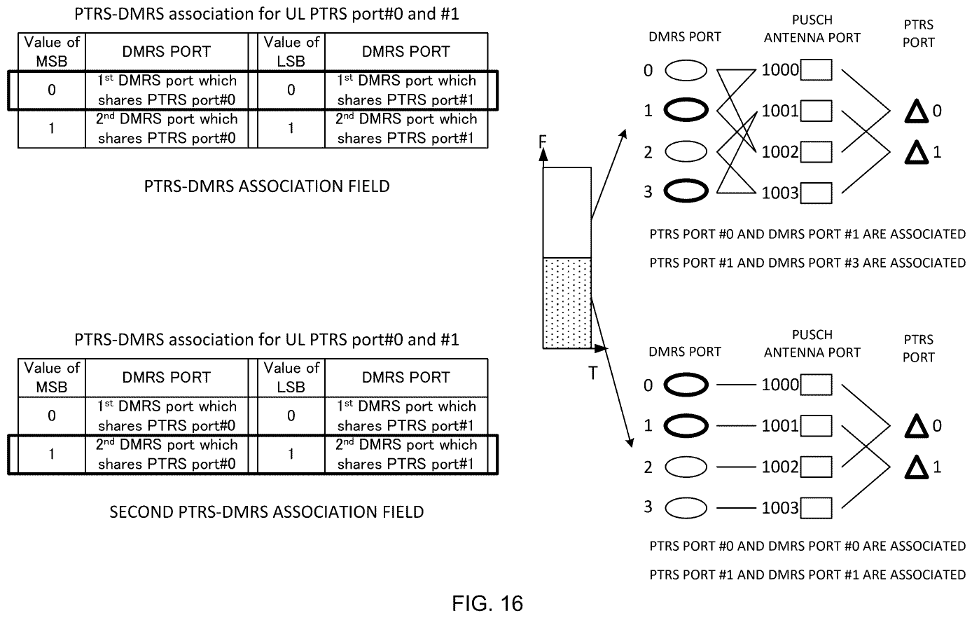

FIG. 16 is a diagram to show an example of the PTRS-DMRS association when two PTRSs (for example, PTRS port 0 and PTRS port 1) are configured/applied. A case is shown in which the PTRS-DMRS association field and the second PTRS-DMRS association field included in DCI indicate the PTRS-DMRS association for the first beam/first panel/first TRP and the PTRS-DMRS association for the second beam/second panel/second TRP.

In FIG. 16, the PTRS-DMRS association field (here, the MSB is 0 and the LSB is 0) included in DCI indicates the PTRS-DMRS association for the first beam/first panel/first TRP. In this case, in the first beam/first panel/first TRP, PTRS 0 is associated with the first DMRS port sharing PTRS port 0, and PTRS 1 is associated with the first DMRS port sharing PTRS port 1.

The second PTRS-DMRS association field (here, the MSB is 1 and the LSB is 1) included in DCI indicates the PTRS-DMRS association for the second beam/second panel/second TRP. In this case, in the second beam/second panel/second TRP, PTRS 0 is associated with the second DMRS port sharing PTRS port 0, and PTRS 1 is associated with the second DMRS port sharing PTRS port 1.

The first TPMI and the second TPMI may separately indicate the correspondence between the DMRS ports and the PUSCH antenna ports to the UE. Here, the first TPMI indicates that DMRS port 0 and PUSCH antenna port 1000 correspond to each other, DMRS port and PUSCH antenna port 1001 correspond to each other, DMRS port 2 and PUSCH antenna port 1002 correspond to each other, and DMRS port 3 and PUSCH antenna port 1003 correspond to each other. The second TPMI indicates that DMRS port 0 and PUSCH antenna ports 1000 and 1002 correspond to each other, DMRS port 1 and PUSCH antenna ports 1000 and 1002 correspond to each other, DMRS port 2 and PUSCH antenna ports 1001 and 1003 correspond to each other, and DMRS port 3 and PUSCH antenna ports 1001 and 1003 correspond to each other.

In this case, it means that PTRS 0 is associated with DMRS port 0 (first DMRS port sharing PTRS port 0) and PTRS 1 is associated with DMRS port 1 (first DMRS port sharing PTRS port 1) in the first beam/first panel/first TRP.

It means that PTRS 0 is associated with DMRS port 1 (second DMRS port sharing PTRS port 0) and PTRS 1 is associated with DMRS port 3 (second DMRS port sharing PTRS port 1) in the second beam/second panel/second TRP.

### Third Embodiment

A third embodiment relates to a case in which the SDM scheme (or SDM repetition) is configured for UL transmission. “Configure” may be interpreted as “indicate”, “apply”, “activate”, or “enable”.

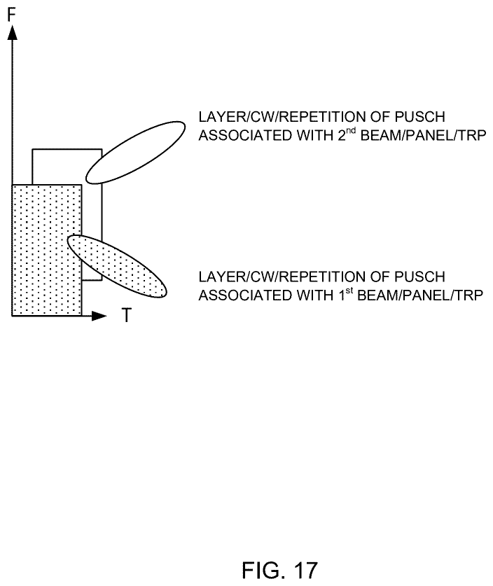

When the UE performs UL transmission (here, a PUSCH) using a plurality of (for example, two) beams/panels/TRPs, different layers/DMRS ports of one PUSCH (for example, different layers/DMRS ports of one PUSCH) may be separately precoded, and may be simultaneously transmitted from different UE panels (see FIG. 17). In the SDM scheme (or SDM repetition), one or two CWs (or TBs) may be supported.

The UE may control transmission, using the layer/CW/repetition of the PUSCH associated with the first beam/panel/TRP and the layer/CW/repetition of the PUSCH associated with the second beam/panel/TRP.

Two beams/panels/TRPs may have different DMRS ports. In the following description, a case is assumed in which two beams/panels/TRPs have different DMRS ports, but this is not restrictive. Similar application may also be carried out when three or more beams/panels/TRPs are used.

### Option 3-1

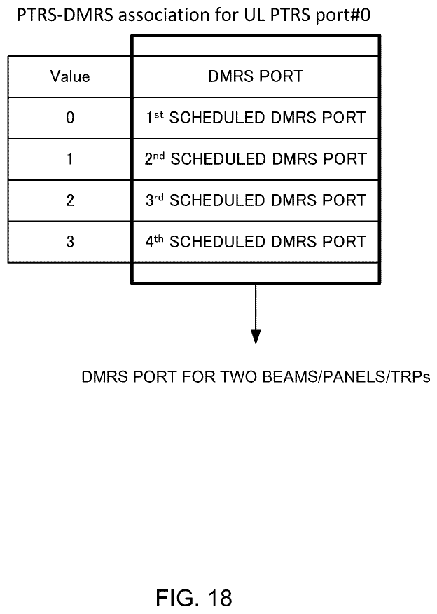

When one PTRS (for example, PTRS port 0) is configured/applied, one PTRS-DMRS association may be indicated. DMRS ports for two beams/panels/TRPs may be indicated (see FIG. 18). For example, the base station may indicate one PTRS-DMRS association to the UE, using the PTRS-DMRS association field included in DCI. The base station may select the DMRS port corresponding to PTRS port 0 out of the DMRS ports for two beams/panels/TRPs, and indicate the DMRS port to the UE. As an example, the PTRS-DMRS association field supported in Rel. 16 may be reused.

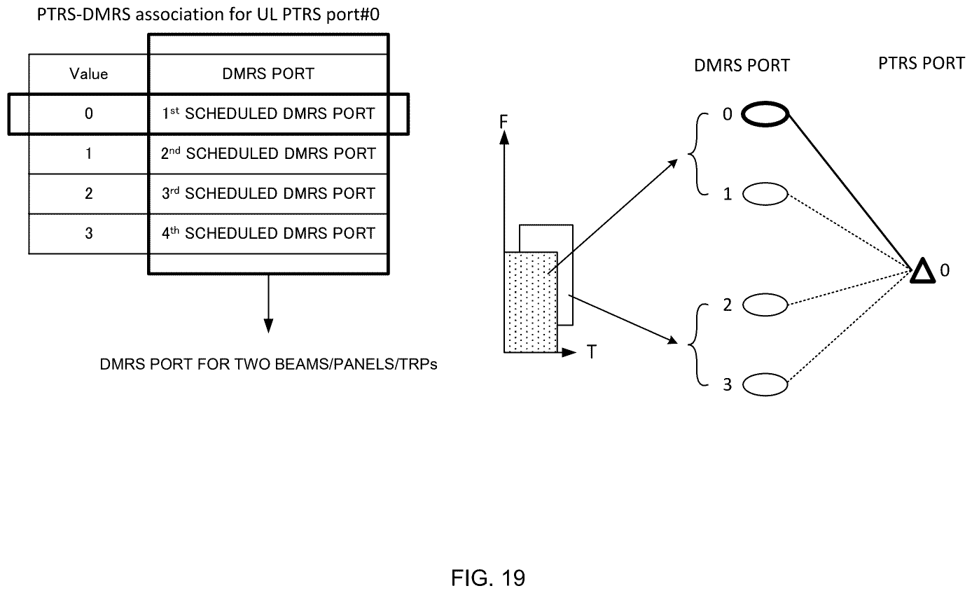

FIG. 19 is a diagram to show an example of the PTRS-DMRS association when one PTRS (for example, PTRS port 0) is configured/applied. A case is shown in which the PTRS-DMRS association field (here, 0) included in DCI indicates a certain DMRS port (here, a 1^{st} scheduled DMRS port). In this case, it may mean that PTRS port 0 is associated with DMRS port 0 out of DMRS ports 0 to 3 for two beams/panels/TRPs.

### Option 3-2

When two PTRSs (for example, PTRS port 0/port 1) are configured/applied, PTRS port 0/port 1 may be respectively configured/applied for the first/second beam/panel/TRP. PTRS port 0 may be associated with the DMRS port transmitted in the first beam/panel/TRP. PTRS port 1 may be associated with the DMRS port transmitted in the second beam/panel/TRP.

### Option 3-2-1

When PTRS port 0/port 1 is respectively applied to the first/second beam/panel/TRP, one PTRS-DMRS association may be indicated. Two beams/panels/TRPs may share the same indication.

For example, the UE may apply information (for example, one PTRS-DMRS association field) related to the PTRS-DMRS association indicated from the base station to two beams/panels/TRPs.

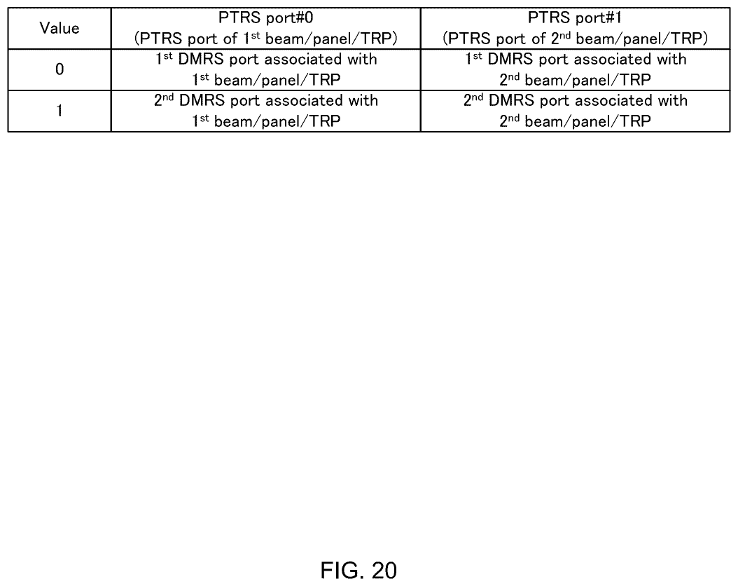

FIG. 20 is a diagram to show an example of the PTRS-DMRS association (for example, one PTRS-DMRS association field) indicated to the UE.

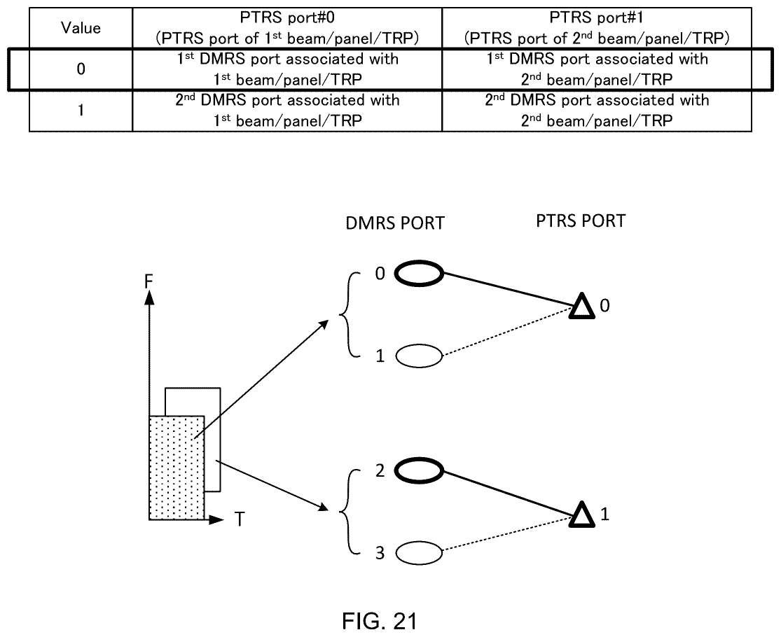

When the PTRS-DMRS association field indicates a first value (for example, 0), it may mean that PTRS port 0 corresponding to the first beam/panel/TRP and the first DMRS port (here, DMRS port 0) associated with the first beam/panel/TRP are associated. Moreover, it may mean that PTRS port 1 corresponding to the second beam/panel/TRP and the first DMRS port (here, DMRS port 2) associated with the second beam/panel/TRP are associated (see FIG. 21).

When the PTRS-DMRS association field indicates a second value (for example, 1), it may mean that PTRS port 0 corresponding to the first beam/panel/TRP and the second DMRS port (here, DMRS port 1) associated with the first beam/panel/TRP are associated. Moreover, it may mean that PTRS port 1 corresponding to the second beam/panel/TRP and the second DMRS port (here, DMRS port 3) associated with the second beam/panel/TRP are associated.

### Option 3-2-2

When PTRS port 0/port 1 is respectively applied to the first/second beam/panel/TRP, two PTRS-DMRS associations may be respectively indicated for two beams/panels/TRPs.

In this case, the PTRS-DMRS association may be indicated by one field (for example, one PTRS-DMRS association field) (option 3-2-2-1). Alternatively, the PTRS-DMRS association may be indicated by two fields (for example, two PTRS-DMRS association fields) (option 3-2-2-2).

### Option 3-2-2-1

When the PTRS-DMRS association is indicated by one field, each beam/panel/TRP may have up to X layers (for example, X=2), the MSB of the field may indicate the PTRS-DMRS association for the first beam/panel/TRP, and the LSB of the field may indicate the PTRS-DMRS association for the second beam/panel/TRP.

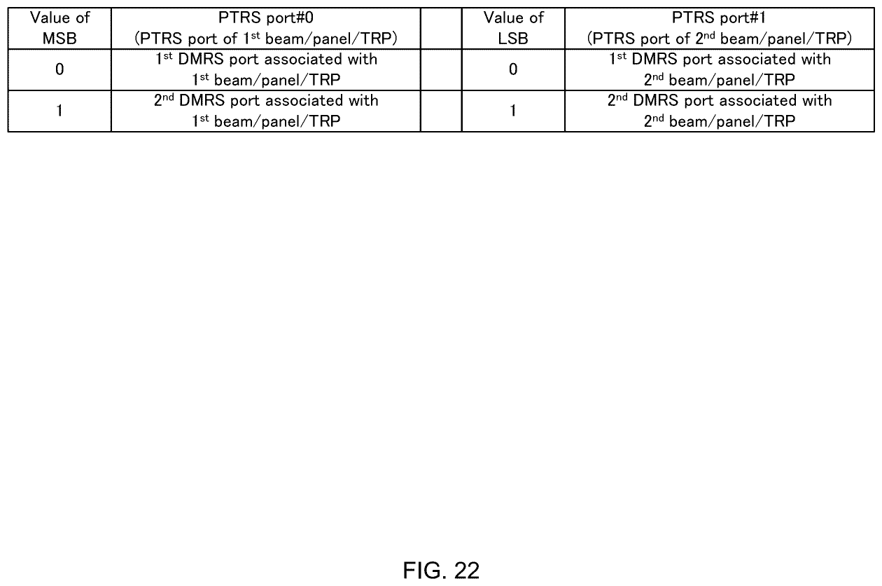

FIG. 22 is a diagram to show an example of an association indication (for example, one PTRS-DMRS association field) for the PTRS-DMRS indicated to the UE.

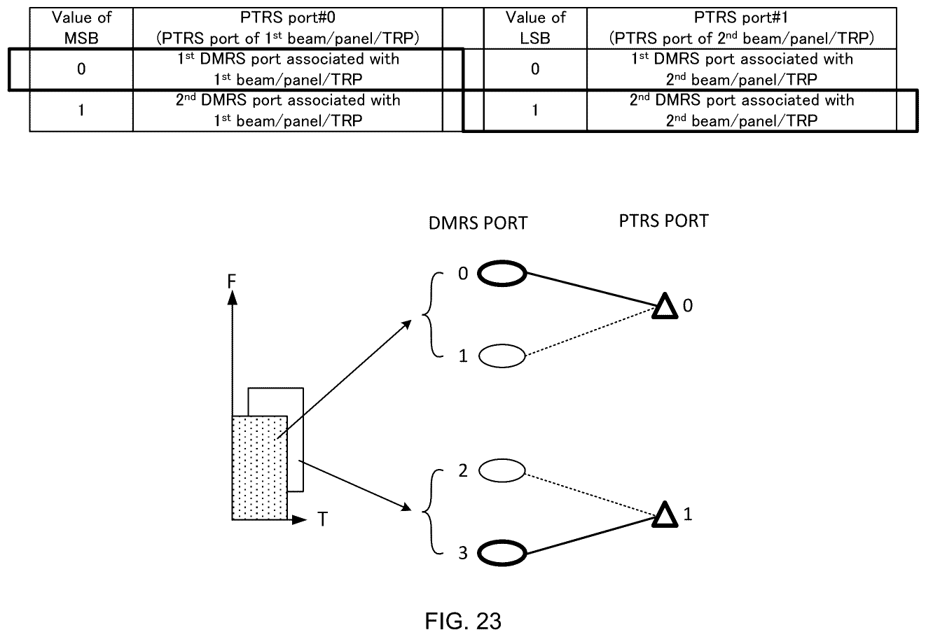

The UE may determine the DMRS port associated with PTRS port 0 and the DMRS port associated with PTRS port 1, based on the MSB and the LSB of the PTRS-DMRS association field. For example, a case is assumed in which, when the MSB of the PTRS-DMRS association field is 0, the LSB thereof is 1 (see FIG. 23).

In this case, it may mean that PTRS port 0 corresponding to the first beam/panel/TRP and the first DMRS port (here, DMRS port 0) associated with the first beam/panel/TRP are associated. Moreover, it may mean that PTRS port 1 corresponding to the second beam/panel/TRP and the second DMRS port (here, DMRS port 3) associated with the second beam/panel/TRP are associated (see FIG. 23).

Note that a configuration (for example, layer combination) may be supported in which the number of layers (for example, the maximum number of layers) applied/configured for each beam/panel/TRP is different. For example, a configuration (for example, layer combination 1+3) may be supported in which one of the first beam/panel/TRP and the second beam/panel/TRP supports one layer and the other supports three layers.

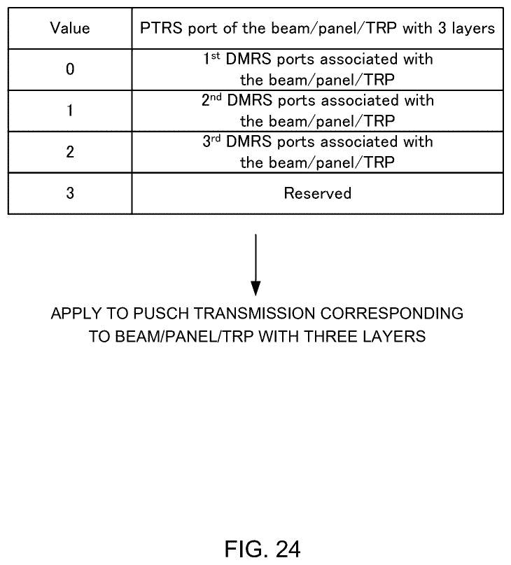

FIG. 24 is a diagram to show an example of an association indication (for example, one PTRS-DMRS association field) for the PTRS-DMRS when layer combination 1+3 is indicated/configured.

In this case, the PTRS-DMRS association (for example, the PTRS-DMRS association field) may be indicated for one beam/panel/TRP supporting three layers, and the PTRS-DMRS association (for example, indication using the PTRS-DMRS association field) may be unnecessary for one beam/panel/TRP applying one layer.

The UE may determine the DMRS port associated with the PTRS port of one beam/panel/TRP (for example, the beam/panel/TRP having three layers), based on the PTRS-DMRS association field.

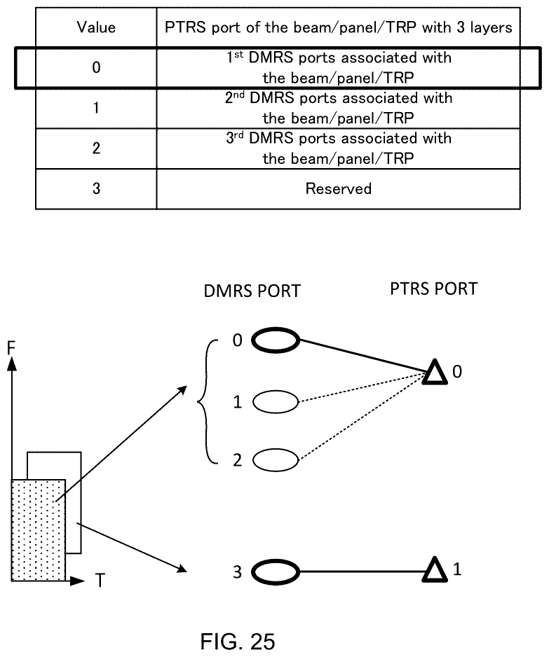

For example, a case is assumed in which the PTRS-DMRS association field indicates the first DMRS port (here, 0) (see FIG. 25). In this case, it may mean that the PTRS port corresponding to one beam/panel/TRP (for example, the first beam/panel/TRP having three layers) and the first DMRS port (here, DMRS port 0) associated with the one beam/panel/TRP are associated.

The UE may determine that one PTRS 1 and one DMRS port 3 defined/configured in advance are associated regarding the other beam/panel/TRP (for example, the second beam/panel/TRP having three layers).

### Option 3-2-2-2

When the PTRS-DMRS association is indicated using two fields (for example, two PTRS-DMRS association fields), a first field may be associated with the first beam/panel/TRP and a second field may be associated with the second beam/panel/TRP.

When the PTRS-DMRS association is indicated using two fields, each beam/panel/TRP may have up to X layers (for example, X=2) and each field may include Y bits (for example, Y=1).

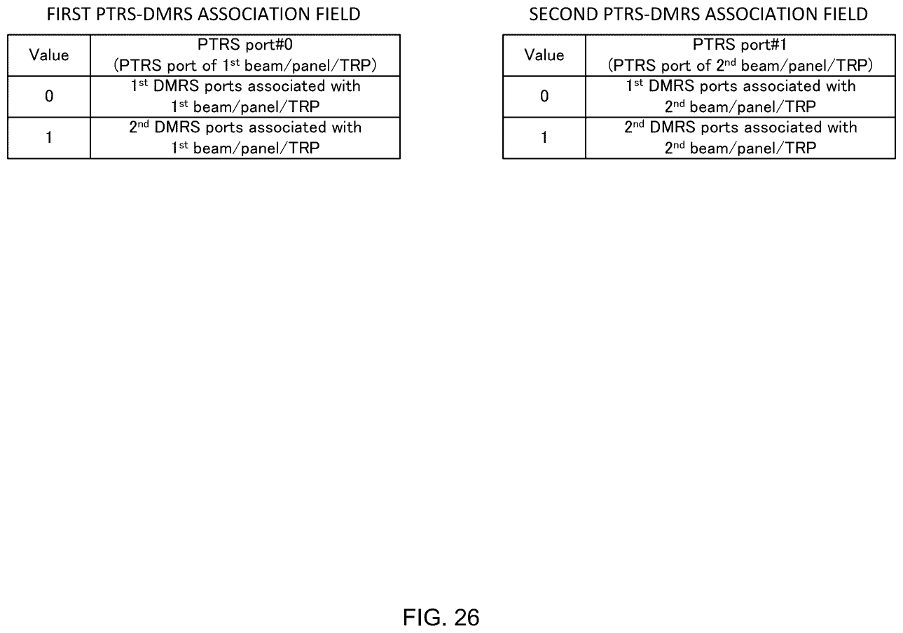

FIG. 26 is a diagram to show an example of an association indication (for example, one PTRS-DMRS association field) for the PTRS-DMRS indicated to the UE. Here, a case is shown in which the first field indicating the DMRS ports associated with PTRS port 0 corresponding to the first beam/panel/TRP and the second field indicating the DMRS ports associated with PTRS port 1 corresponding to the second beam/panel/TRP are applied/configured.

The UE may determine the DMRS port associated with PTRS port 0 based on the first PTRS-DMRS association field, and determine the DMRS port associated with PTRS port 1 based on the second PTRS-DMRS association field.

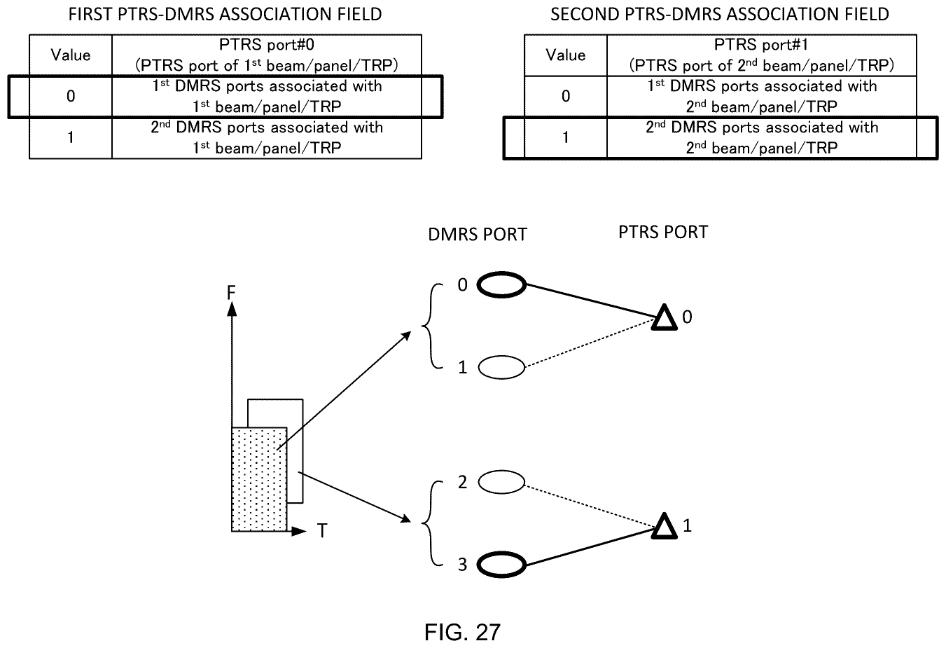

For example, a case is assumed in which, when the MSB of the PTRS-DMRS association field is 0, the LSB thereof is 1 (see FIG. 27).

In this case, it may mean that PTRS port 0 corresponding to the first beam/panel/TRP and the first DMRS port (here, DMRS port 0) associated with the first beam/panel/TRP are associated. It may mean that PTRS port 1 corresponding to the second beam/panel/TRP and the second DMRS port (here, DMRS port 3) associated with the second beam/panel/TRP are associated (see FIG. 27).

Note that a configuration (for example, layer combination) may be supported in which the number of layers (for example, the maximum number of layers) applied/configured for each beam/panel/TRP is different. For example, a configuration (for example, layer combination 1+3) may be supported in which one of the first beam/panel/TRP and the second beam/panel/TRP supports one layer and the other supports three layers.

In this case, the PTRS-DMRS association field corresponding to the beam/panel/TRP supporting three layers may have 2 bits, and the PTRS-DMRS association field corresponding to the beam/panel/TRP supporting one layer may have 0 bits (or may not be included in DCI).

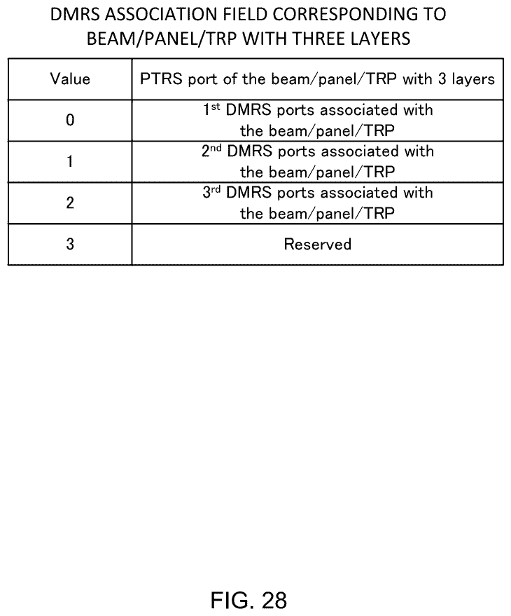

FIG. 28 is a diagram to show an example of association indication (for example, the PTRS-DMRS association field corresponding to the beam/panel/TRP supporting three layers) for the PTRS-DMRS when layer combination 1+3 is indicated/configured.

In this case, the PTRS-DMRS association (for example, the PTRS-DMRS association field) may be indicated for one beam/panel/TRP supporting three layers, and the PTRS-DMRS association (for example, the PTRS-DMRS association field) may be unnecessary for one beam/panel/TRP applying one layer.

The UE may determine the DMRS port associated with the PTRS port of one beam/panel/TRP (for example, the beam/panel/TRP having three layers), based on the PTRS-DMRS association field.

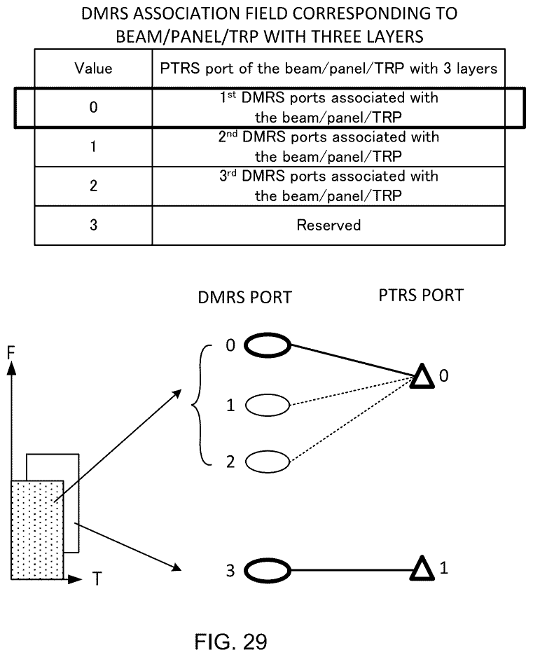

For example, a case is assumed in which the PTRS-DMRS association field indicates the first DMRS port (here, 0) (see FIG. 29). In this case, it may mean that PTRS port 0 corresponding to one beam/panel/TRP (for example, the beam/panel/TRP having three layers) and the first DMRS port (here, DMRS port 0) associated with the one beam/panel/TRP are associated.

### Variations

In existing systems (for example, Rel. 16), it is defined that the DMRS port transmitted in PUSCH antenna ports 1000 and 1002 shares PTRS port 0 and the DMRS port transmitted in PUSCH antenna ports 1001 and 1003 shares PTRS port 1. When one PTRS port is used in one beam/panel/TRP, the PTRS-DMRS association indication (for example, the PTRS-DMRS association field) in Rel. 16 may be reused as follows.

When the SDM scheme/SDM repetition is configured/indicated and two PTRS ports are applied, PTRS port 0/1 may be respectively applied to the first/second beam/panel/TRP. PTRS port 0 may be associated with the DMRS port transmitted in the first beam/panel/TRP. PTRS port 1 may be associated with the DMRS port transmitted in the second beam/panel/TRP.

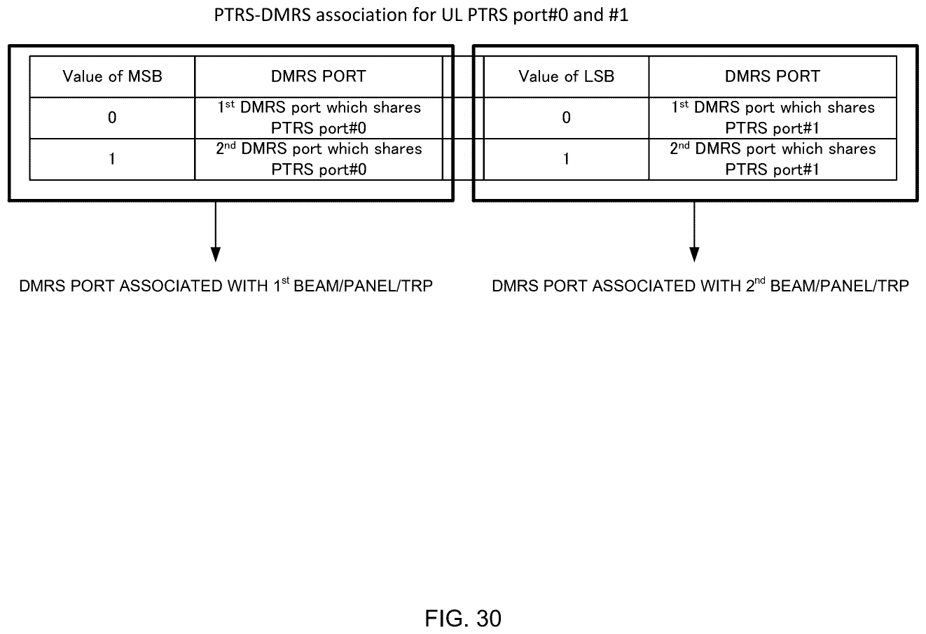

The DMRS port transmitted in PUSCH antenna ports 1000 and 1002 may share PTRS port 0, and the DMRS port transmitted in PUSCH antenna ports 1001 and 1003 may share PTRS port 1. Moreover, it may be defined that PUSCH antenna ports 1000 and 1002 are associated with one beam/panel/TRP (for example, the first beam/panel/TRP), and PUSCH antenna ports 1001 and 1003 are associated with one beam/panel/TRP (for example, the second beam/panel/TRP). The DMRS port associated with the first beam/panel/TRP may share PTRS port 0, and the DMRS port associated with the second beam/panel/TRP may share PTRS port 1 (see FIG. 30).

Consequently, even when simultaneous transmission using a multi-panel is supported, the field (for example, the PTRS-DMRS association field) supported in Rel. 16 can be directly used.

In the SDM scheme/SDM repetition, the UE may assume/expect that two PTRS ports are configured. In other words, the UE may invariably assume/expect that one PTRS port is applied to each beam/panel/TRP.

### Fourth Embodiment

A fourth embodiment relates to single-panel transmission (for example, single panel Tx) and dynamic switching between the schemes (for example, the FDM-A scheme/FDM-B scheme/SDM scheme/SDM repetition).

### FDM-A Scheme/FDM-B Scheme

Single-panel transmission and dynamic switching between the FDM-A scheme/FDM-B scheme are assumed.

When single-panel transmission is indicated and one PTRS-DMRS association field is assumed to be indicated, interpretation of the PTRS-DMRS association field may conform to the association supported in Rel. 16 for the single-panel transmission. The association may be interpreted as a table.

When two PTRS-DMRS association fields are assumed to be indicated, at least one of the following Alt. 1 to Alt. 2 may be applied to the single-panel transmission.

### Alt. 1

The first PTRS-DMRS association field may be applied. Interpretation of the field may conform to the association supported in Rel. 16. The association may be interpreted as a table. The second PTRS-DMRS association field may be ignored.

### Alt. 2

The PTRS-DMRS association field corresponding to an indicated panel may be applied to single-panel transmission. Interpretation of the field may conform to the association supported in Rel. 16. The association may be interpreted as a table. Other PTRS-DMRS association fields may be ignored. The first/second PTRS-DMRS association field may respectively correspond to the first/second panel.

### SDM Scheme/SDM Repetition

Single-panel transmission and dynamic switching between the SDM scheme/SDM repetition are assumed. When two PTRS ports are configured, at least one of the following option 4-1 to option 4-2 may be applied.

### Option 4-1

When single-panel transmission is indicated, use of two PTRS ports is supported, and one PTRS-DMRS association field is assumed to be indicated, interpretation of the PTRS-DMRS association field may conform to the association 41 two PTRS ports supported in Rel. 16 for the single-panel transmission. The association may be interpreted as a table.

When single-panel transmission is indicated, use of two PTRS ports is supported, and two PTRS-DMRS association fields are assumed to be indicated, at least one of the following Alt. 1 to Alt. 2 may be applied to the single-panel transmission.

### Alt. 1

The first PTRS-DMRS association field may be applied. Interpretation of the field may conform to the association of two PTRS ports supported in Rel. 16. The second PTRS-DMRS association field may be ignored. The association may be interpreted as a table.

### Alt. 2

The PTRS-DMRS association field corresponding to an indicated panel may be applied to single-panel transmission. Interpretation of the field may conform to the association of two PTRS ports supported in Rel. 16. The association may be interpreted as a table. Other PTRS-DMRS association fields may be ignored. The first/second PTRS-DMRS association field may respectively correspond to the first/second panel.

### Option 4-2

When single-panel transmission is indicated, use of one PTRS port is supported, and one PTRS-DMRS association field is assumed to be indicated, interpretation of the PTRS-DMRS association field may conform to the association of one PTRS port supported in Rel. 16 for the single-panel transmission. The association may be interpreted as a table.

When single-panel transmission is indicated, use of one PTRS port is supported, and two PTRS-DMRS association fields are assumed to be indicated, at least one of the following Alt. 1 to Alt. 2 may be applied to the single-panel transmission.

### Alt. 1

The first PTRS-DMRS association field may be applied. Interpretation of the field may conform to the association of one PTRS port supported in Rel. 16. The association may be interpreted as a table. The second PTRS-DMRS association field may be ignored.

### Alt. 2

The PTRS-DMRS association field corresponding to an indicated panel may be applied to single-panel transmission. Interpretation of the field may conform to the association of one PTRS port supported in Rel. 16. The association may be interpreted as a table. Other PTRS-DMRS association fields may be ignored. The first/second PTRS-DMRS association field may respectively correspond to the first/second panel.

### Variations

In the first embodiment to the fourth embodiment, “one PTRS” need not be permitted/supported. For example, when the base station configures the FDM-A scheme/FDM-B scheme/SDM scheme/SDM repetition for the single-DCI-based STAMP PUSCH, only two (or two or more) PTRSs may be configured in a certain frequency range (for example, FR2).

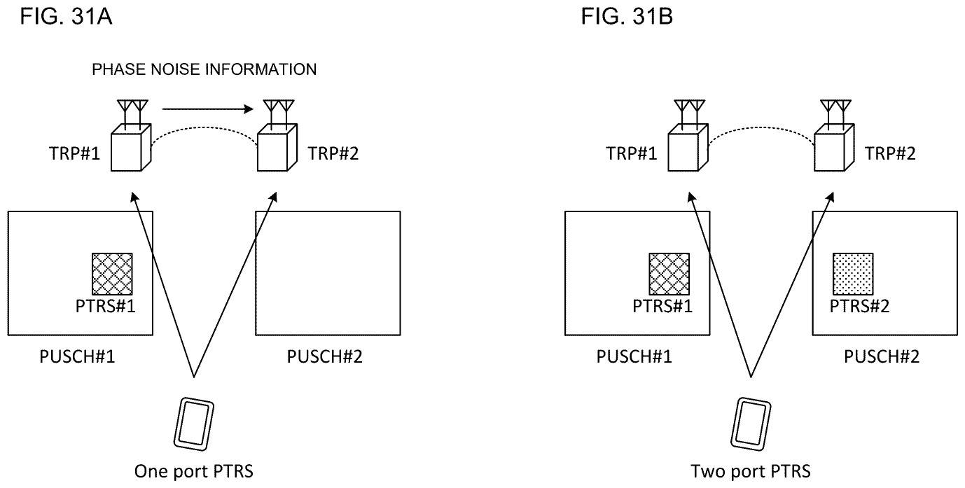

“One PTRS port” may mean that the PTRS is transmitted to one of the TRPs (for example, first TRP #1) (see FIG. 31A). In this case, other TRPs (for example, TRP #2 not receiving the PTRS) may determine/acquire phase noise (for example, phase noise), based on a certain rule. FIG. 31A shows a case in which the UE transmits one PTRS #1. FIG. 31B shows a case in which the UE transmits two PTRSs #1 and #2.

For example, TRP #1 may perform transmission/notification of phase noise information (or PTRS measurement results) to TRP #2 (see FIG. 31A). For the transmission/notification from TRP #1 to TRP #2, a front/middle/backhaul, an X2 link, or the like may be used. In this case, a power amplifier (PA) is common to different UE panels, and thus it may be assumed that phase noise is common to two PUSCHs for different TRPs.

The UE may report panel estimation of the UE that the PA is common to PUSCHs for different panels/TRPs (for example, the same PTRS may be used for two PUSCHs), or may report the number of PTRS ports (for example, {2, 1 and 2}).

### Supplements

In the first embodiment to the fourth embodiment, the FDM-A scheme/FDM-B scheme/SDM scheme/SDM repetition may be indicated/configured by at least one of a higher layer parameter indicating the transmission scheme (for example, the transmission scheme), DCI indicating the transmission scheme, DCI indicating two beams (SRIs/TCI states)/panels, DCI indicating two SRI fields/TCI fields, a configuration of two CB/NCB SRS resource sets, and DCI indicating two or multiple DCM groups for the SDM scheme.

The single-panel transmission may be indicated/configured by at least one of a higher layer parameter/DCI for enabling none of the StxMP transmission schemes, DCI indicating one beam (SRI/TCI state)/panel, DCI indicating one SRI field/TCI field, and a configuration of a CB/NCB SRS resource set.

At least one of the embodiments described above may be applied only to the UE that has reported a specific UE capability or that supports the specific UE capability.

The specific UE capability may indicate at least one of the following:
Support specific processing/operation/control/information (for example, . . . ) regarding at least one of the embodiments described above,
Support the FDM-A scheme,
Support the FDM-B scheme,
Support the SDM scheme,
Support the SDM repetition.

The specific UE capability may be a capability applied to all of the frequencies (in common regardless of a frequency), may be a capability for each frequency (for example, one or a combination of a cell, a band, a band combination, a BWP, a component carrier, and the like), may be a capability for each frequency range (for example, Frequency Range 1 (FR1), FR2, FR3, FR4, FR5, FR2-1, FR2-2), may be a capability for each subcarrier spacing (SCS), or may be a capability for each Feature Set (FS) or Feature Set Per Component-carrier (FSPC).

The specific UE capability may be a capability applied to all of the duplex methods (in common regardless of a duplex method), or may be a capability for each duplex method (for example, time division duplex (TDD), frequency division duplex (FDD)).

At least one of the embodiments described above may be applied when the UE is configured with specific information related to the embodiments described above using higher layer signaling.

When the UE does not support at least one of the specific UE capabilities or is not configured with the specific information, the UE may apply Rel-15/16/17 operation, for example.

### Supplementary Note

Regarding one embodiment of the present disclosure, the following supplementary notes of the invention will be given.

### Supplementary Note 1

A terminal including:
a receiving section that receives information related to a transmission scheme for an uplink shared channel (PUSCH) to be transmitted using at least one of a plurality of beams, panels, and transmission/reception points and downlink control information including information indicating an association between an uplink phase tracking reference signal (PTRS) and a demodulation reference signal (DMRS) for the PUSCH; and
a control section that determines an association between ports of the PTRS and ports of the DMRS, based on the transmission scheme to be applied to the PUSCH, the downlink control information, and a number of the ports of the PTRS to be applied.

### Supplementary Note 2

The terminal according to supplementary note 1, wherein when the transmission scheme to be applied to the PUSCH is a frequency division multiplexing scheme or a space division multiplexing scheme, the control section applies the association between the ports of the PTRS and the ports of the DMRS in common to at least one of the plurality of beams, panels, and transmission/reception points.

### Supplementary Note 3

The terminal according to supplementary note 1 or 2, wherein when the transmission scheme to be applied to the PUSCH is a frequency division multiplexing scheme or a space division multiplexing scheme, the control section applies the association between the ports of the PTRS and the ports of the DMRS separately to at least one of the plurality of beams, panels, and transmission/reception points.

### Supplementary Note 4

The terminal according to any one of supplementary notes 1 to 3, wherein the control section determines the association between the ports of the PTRS and the ports of the DMRS for at least one of the plurality of beams, panels, and transmission/reception points, based on one field included in the downlink control information.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

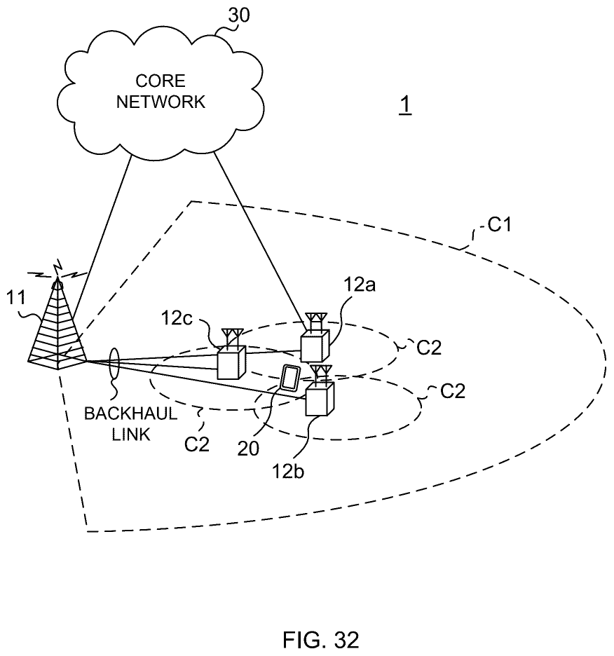

FIG. 32 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR 2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility management Function (AMF), a Session Management Function (SMF), Unified Data Management (UDM), an Application Function (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (physical random access channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

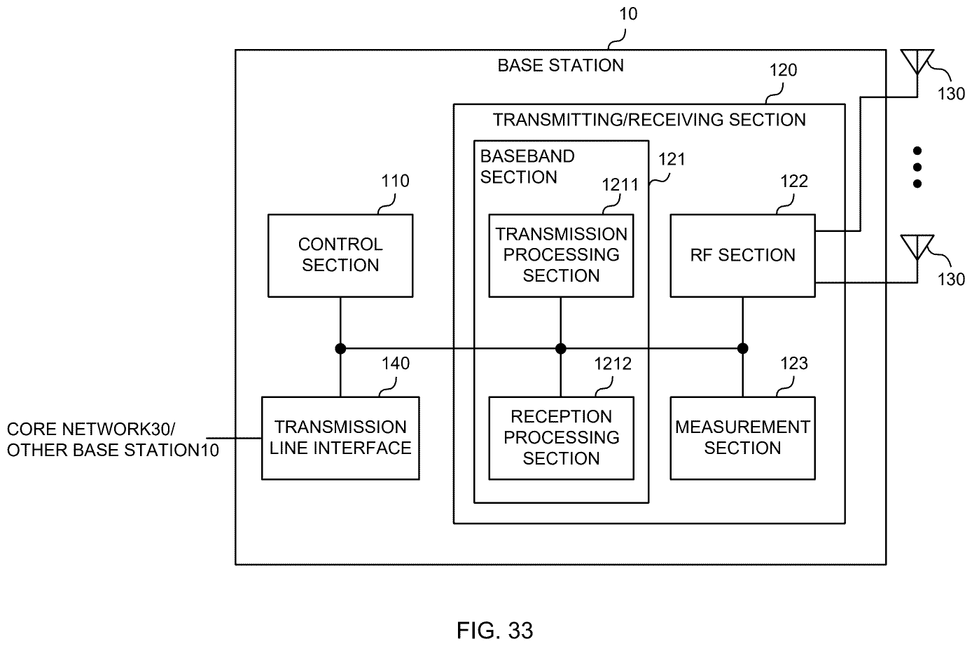

FIG. 33 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may transmit/receive (perform backhaul signaling of) a signal with an apparatus (for example, a network node providing NFs) included in the core network 30 or other base stations 10, and so on, and may acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit information related to a transmission scheme for an uplink shared channel (PUSCH) to be transmitted using at least one of a plurality of beams, panels, and transmission/reception points and downlink control information including information indicating an association between an uplink phase tracking reference signal (PTRS) and a demodulation reference signal (DMRS) for the PUSCH.

The control section 110 may perform control to indicate an association between ports of the PTRS and ports of the DMRS, based on the transmission scheme to be applied to the PUSCH, the downlink control information, and a number of the ports of the PTRS to be applied.

### User Terminal

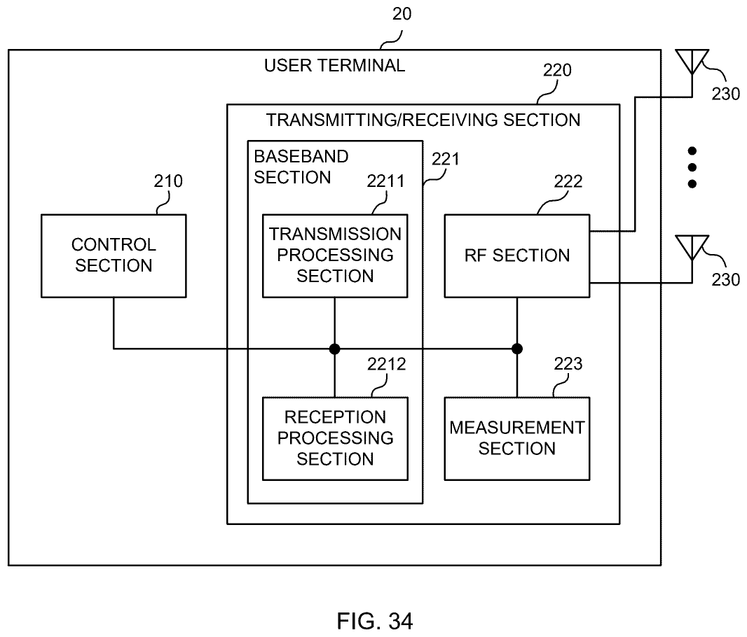

FIG. 34 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to a transmission scheme for an uplink shared channel (PUSCH) to be transmitted using at least one of a plurality of beams, panels, and transmission/reception points and downlink control information including information indicating an association between an uplink phase tracking reference signal (PTRS) and a demodulation reference signal (DMRS) for the PUSCH.

The control section 210 may determine an association between ports of the PTRS and ports of the DMRS, based on the transmission scheme to be applied to the PUSCH, the downlink control information, and a number of the ports of the PTRS to be applied.

When the transmission scheme to be applied to the PUSCH is a frequency division multiplexing scheme or a space division multiplexing scheme, the control section 210 may apply the association between the ports of the PTRS and the ports of the DMRS in common to at least one of the plurality of beams, panels, and transmission/reception points.

When the transmission scheme to be applied to the PUSCH is a frequency division multiplexing scheme or a space division multiplexing scheme, the control section 210 may apply the association between the ports of the PTRS and the ports of the DMRS separately to at least one of the plurality of beams, panels, and transmission/reception points.

The control section 210 may determine the association between the ports of the PTRS and the ports of the DMRS for at least one of the plurality of beams, panels, and transmission/reception points, based on one field included in the downlink control information.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (separate apparatus) (for example, via wire, wireless, or the like) and using these plurality of pieces of apparatus (these plurality of apparatus). The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

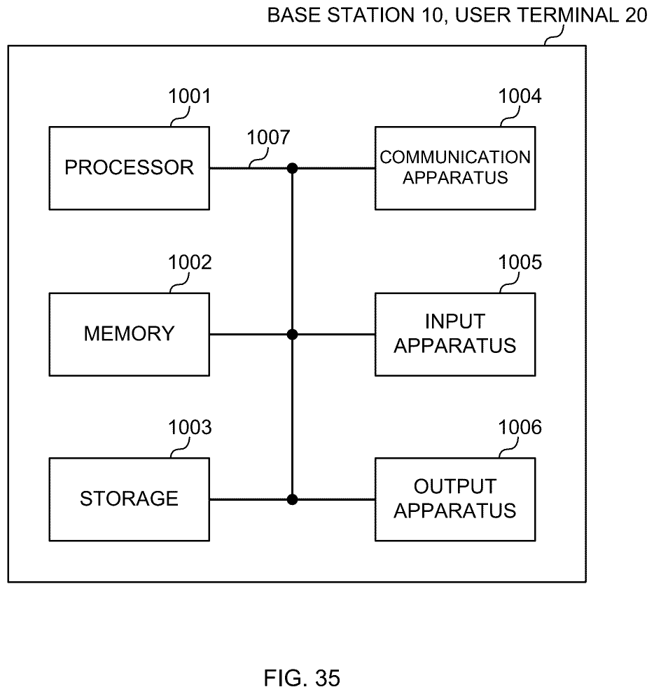

For example, a base station, a user terminal, and so on according to one embodiment of the present disclosure may function as a computer that executes the processes of the radio communication method of the present disclosure. FIG. 35 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used.

For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus (between apparatus).

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware (at least one of these hardware).

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CES).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interchangeably interpreted as a case that the base station indicates, for the terminal, control/operation based on the information.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

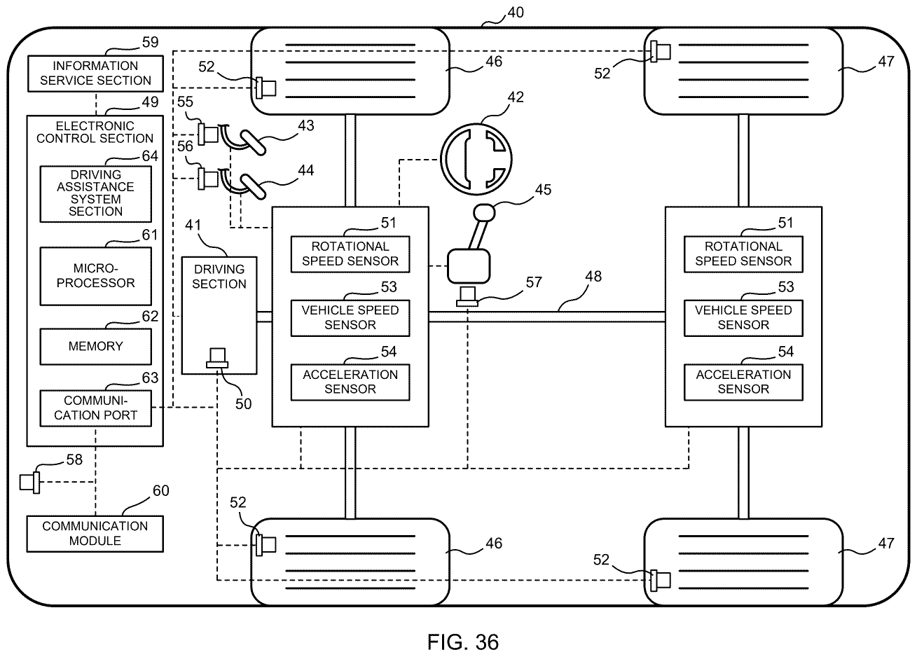

FIG. 36 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information (various information) such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a receiver that receives first information indicating a transmission scheme for a physical uplink shared channel (PUSCH) to be transmitted using a plurality of panels and second information indicating a number of uplink phase tracking reference signal (PTRS) ports, and receives downlink control information including third information indicating an association between a PTRS and a demodulation reference signal (DMRS) for the PUSCH; and
a processor that determines an association between a port of the PTRS and a port of the DMRS, based on the first information, the number of PTRS ports configured by the second information, and the third information included in the downlink control information.

8. The terminal according to claim 7, wherein when the first information indicates a space division multiplexing scheme and the number of PTRS ports configured by the second information is 2, a first PTRS port is associated with a DMRS port corresponding to a first sounding reference signal resource indicator (SRI) field, and a second PTRS port is associated with a DMRS port corresponding to a second SRI field.

9. The terminal according to claim 7, wherein when the first information indicates a space division multiplexing scheme and the number of PTRS ports configured by the second information is 2, a most significant bit of the third information indicates an association between the PTRS and the DMRS corresponding to a first sounding reference signal resource indicator (SRI) field, and a least significant bit of the third information indicates an association between the PTRS and the DMRS corresponding to a second SRI field.

10. The terminal according to claim 7, wherein when the first information indicates a space division multiplexing scheme and the number of PTRS ports configured by the second information is 1, the third information indicates an association of one PTRS port with DMRS ports corresponding to a first sounding reference signal resource indicator (SRI) field and a second SRI field.

11. A radio communication method for a terminal, comprising:
receiving first information indicating a transmission scheme for a physical uplink shared channel (PUSCH) to be transmitted using a plurality of panels and second information indicating a number of uplink phase tracking reference signal (PTRS) ports, and receiving downlink control information including third information indicating an association between a PTRS and a demodulation reference signal (DMRS) for the PUSCH; and
determining an association between a port of the PTRS and a port of the DMRS, based on the first information, the number of PTRS ports configured by the second information, and the third information included in the downlink control information.

12. A base station comprising:
a transmitter that transmits first information indicating a transmission scheme for a physical uplink shared channel (PUSCH) to be transmitted using a plurality of panels and second information indicating a number of uplink phase tracking reference signal (PTRS) ports, and transmits downlink control information including third information indicating an association between a PTRS and a demodulation reference signal (DMRS) for the PUSCH; and
a processor that indicates an association between a port of the PTRS and a port of the DMRS, by using the first information, the number of PTRS ports indicated by the second information, and the third information included in the downlink control information.

13. A system comprising a terminal and a base station, wherein
the terminal comprises:
a receiver that receives first information indicating a transmission scheme for a physical uplink shared channel (PUSCH) to be transmitted using a plurality of panels and second information indicating a number of uplink phase tracking reference signal (PTRS) ports, and receives downlink control information including third information indicating an association between a PTRS and a demodulation reference signal (DMRS) for the PUSCH; and
a processor that determines an association between a port of the PTRS and a port of the DMRS, based on the first information, the number of PTRS ports configured by the second information, and the third information included in the downlink control information, and
the base station comprises:
a transmitter that transmits the first information and the second information, and transmits the downlink control information.
